(19) United States
(12) Patent Application Publication
(10) Pub. No.: US 2026/0257474 A1
(43) Pub. Date: Sep. 3, 2026

(54) INKJET RECORDING APPARATUS AND INKJET RECORDING SYSTEM

(71) Applicant: KEYENCE CORPORATION, Osaka (JP)

(72) Inventor: Hideki Yamakawa, Osaka-shi (JP)

(73) Assignee: KEYENCE CORPORATION, Osaka (JP)

(21) Appl. No.: 19/654,668

(22) Filed: Apr. 22, 2026

Related U.S. Application Data
(63) Continuation of application No. PCT/JP2024/037287, filed on Oct. 19, 2024.

(30) Foreign Application Priority Data
Oct. 31, 2023 (JP) 2023-186839

(51) Int. Cl. B41J 2/09; B41J 2/03; B41J 2/085; B41J 2/165; B41J 2/175; B41J 2/185; F26B 21/00

(52) U.S. Cl. CPC B41J 2/09; B41J 2/03; B41J 2/085; B41J 2/16507; B41J 2/175; B41J 2/185; F26B 21/00; B41J 2002/1853; B41P 2235/26

(57) ABSTRACT

A solvent consumption amount in head cleaning is reduced, and the convenience of an inkjet recording apparatus is enhanced. An inkjet recording apparatus is a continuous inkjet recording apparatus including: a print head that accommodates a nozzle, a charging electrode, a deflection electrode, and a gutter therein; an ink supply unit that supplies ink to the print head; a solvent supply unit that supplies a solvent to the print head; and a control unit that controls ink supply from the ink supply unit to the print head and controls solvent supply from the solvent supply unit to the print head, in which the print head includes an assist unit that assists cleaning when cleaning a component accommodated inside the print head with a solvent supplied from the solvent supply unit.

### CROSS-REFERENCE TO RELATED APPLICATIONS

The present application is a continuation of International Application No. PCT/JP2024/037287, filed Oct. 19, 2024, and claims foreign priority based on Japanese Patent Application No. 2023-186839, filed October 31, 2023, the contents of which are incorporated herein by references.

### BACKGROUND OF THE INVENTION

### 1. TECHNICAL FIELD

The present disclosure relates to a continuous inkjet recording apparatus and an inkjet recording system including the inkjet recording apparatus.

### 2. DESCRIPTION OF THE RELATED ART

JP 2021-091181 A discloses an example of a continuous inkjet recording apparatus.

Specifically, JP 2021-091181 A discloses an inkjet recording system including a print head that accommodates various components therein, and a cleaning placement portion on which the print head is placed when cleaning the print head using a solvent.

In the case of a general continuous inkjet recording apparatus, ink particles continue to fly in the internal space of the print head. Therefore, dirt is likely to accumulate inside the print head. The interior of the print head needs to be periodically cleaned.

Conventionally, cleaning (head cleaning) of a print head has been performed by spraying a solvent into the print head by a user himself/herself, or by automatically ejecting the solvent from a cleaning nozzle provided in the print head after the print head is placed on a cleaning placement portion as in JP 2021-091181 A.

However, when a large amount of dirt accumulates in the print head due to long-term use, a large amount of solvent is consumed regardless of whether the head is cleaned by the user himself/herself or the head is cleaned by a cleaning nozzle. In addition, when a large amount of dirt accumulates, it is not easy to remove the dirt even if head cleaning is performed.

Therefore, it is conceivable to perform head cleaning with high frequency before a large amount of dirt accumulates, that is, before the dirt becomes difficult to remove. However, when the head cleaning is performed with high frequency, the number of times of use of the solvent increases, and thus a large amount of solvent is consumed as a result.

The consumption of a large amount of solvent increases the frequency of solvent replenishment, which is disadvantageous in improving the convenience of the inkjet recording apparatus.

### SUMMARY OF THE INVENTION

The present disclosure has been made in view of such a point, and an object thereof is to reduce a solvent consumption amount in head cleaning and to enhance convenience of an inkjet recording apparatus.

A first aspect of the present disclosure is a continuous inkjet recording apparatus including: a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside; an ink supply unit that supplies ink to the print head; a solvent supply unit that supplies a solvent to the print head; and a control unit that controls ink supply from the ink supply unit to the print head, and controls solvent supply from the solvent supply unit to the print head, in which printing is performed by causing the ink ejected from the print head to land on a printing target object.

According to the first aspect of the present disclosure, the print head includes an assist unit that assists cleaning of a component accommodated inside the print head when the cleaning is performed by a solvent supplied from the solvent supply unit.

According to the first aspect, the amount of solvent consumed in the head cleaning can be reduced by the assist unit assisting the head cleaning. Accordingly, the convenience of the inkjet recording apparatus can be enhanced.

Furthermore, according to a second aspect of the present disclosure, the assist unit may include an air jetting unit that jets air into the print head, and the assist unit may assist the cleaning by bringing the air jetted from the air jetting unit into contact with a solvent supplied from the solvent supply unit.

According to the second aspect, the solvent supplied from the solvent supply unit can be blown to the components in the print head by air. By blowing the solvent onto the components, dirt adhering to the components is easily removed. This makes it possible to exhibit a sufficient cleaning effect while reducing the solvent consumption amount.

Furthermore, according to a third aspect of the present disclosure, the assist unit may apply air jetted from the air jetting unit to a solvent supplied from the solvent supply unit to atomize the solvent, thereby expanding a cleaning area of the component by the solvent.

According to the third aspect, the solvent supplied from the solvent supply unit can be atomized by air and then blown onto the components in the print head. The atomization of the solvent contributes to expansion of a cleaning area of the component. This makes it possible to exhibit a sufficient cleaning effect while reducing the solvent consumption amount.

Furthermore, according to a fourth aspect of the present disclosure, the print head may include an ink ejection port for ejecting ink deflected by the deflection electrode to the outside, and the control unit may include a cleaning management unit that manages an amount of solvent used at the time of cleaning so that an amount of solvent corresponding to air jetted from the air jetting unit is supplied.

According to the fourth aspect, the cleaning management unit manages the amount of solvent used. By this, together with the assist of the cleaning by the assist unit, the solvent consumption amount can be further reduced.

Furthermore, according to a fifth aspect of the present disclosure, the assist unit may include a contact portion located inside the print head and in mechanical contact with the component, and the assist unit may assist the cleaning by bringing the contact portion into contact with a component wetted with a solvent supplied from the solvent supply unit.

According to the fifth aspect, the solvent supplied from the solvent supply unit can be rubbed against the component in the print head by the contact portion. By rubbing the solvent against the component, dirt adhering to the component is easily removed. This makes it possible to exhibit a sufficient cleaning effect while reducing the solvent consumption amount.

Furthermore, according to a sixth aspect of the present disclosure, the assist unit may bring the contact portion into contact with a solvent supplied from the solvent supply unit and wipe off the solvent, thereby expanding a cleaning area of the component by the solvent.

According to the sixth aspect, the solvent supplied from the solvent supply unit can be wiped off the component in the print head by the contact portion. Wiping of the solvent contributes to the enlargement of the cleaning area of the component. This makes it possible to exhibit a sufficient cleaning effect while reducing the solvent consumption amount.

Furthermore, according to a seventh aspect of the present disclosure, the control unit may include a cleaning management unit that manages an amount of solvent used during the cleaning so that a surface of the component is wetted by a solvent supplied from the solvent supply unit.

According to the seventh aspect, the cleaning management unit manages the amount of solvent used. By this, together with the assist of the cleaning by the assist unit, the solvent consumption amount can be further reduced.

Furthermore, according to an eighth aspect of the present disclosure, the air jetting unit may jet air toward the deflection electrode, and be arranged so as to interpose a shaft-like solvent ejected from the nozzle between the air jetting unit and the deflection electrode.

According to the eighth aspect, the solvent supplied from the nozzle can be blown to the components in the print head by air. In the case of a general continuous inkjet recording apparatus, the ejection amount of the solvent from the nozzle can be precisely controlled. Precise control of the ejection amount of the solvent contributes to reduction of solvent consumption amount.

Furthermore, in general, the dirt caused by the ink gradually accumulates on the deflection electrode as the inkjet recording apparatus is repeatedly used. On the other hand, according to the eighth aspect, the solvent can be blown to the deflection electrode, and dirt adhering to the deflection electrode is easily removed. This is advantageous in exerting a sufficient cleaning effect while reducing the solvent consumption amount.

Furthermore, according to a ninth aspect of the present disclosure, the deflection electrode may include first and second electrode plates facing each other, and the air jetting unit may be arranged on the first electrode plate so as to jet air toward the second electrode plate.

According to the ninth aspect, by arranging the air jetting unit on the first electrode plate, the air jetting unit and the shaft-like solvent can be brought as close as possible. This is advantageous in that blowing of the solvent is more reliably realized and a sufficient cleaning effect is exhibited while reducing the solvent consumption amount.

Furthermore, according to a tenth aspect of the present disclosure, the first electrode plate may be grounded.

In general, a high voltage is applied to the second electrode plate that is not grounded. In this case, the charged ink is attracted to the second electrode plate more than the grounded first electrode plate. The second electrode plate is more likely to accumulate dirt than the first electrode plate.

On the other hand, according to the tenth aspect, the air jetting unit blows the solvent toward the second electrode plate at the time of assist by the assist unit. This makes it possible to more reliably clean the second electrode plate that is assumed to be likely to accumulate dirt.

Furthermore, according to an eleventh aspect of the present disclosure, the print head may include an ink ejection port for ejecting ink deflected by the deflection electrode to the outside, and the second electrode plate may include: an inclined surface inclined in a direction away from the shaft-like solvent; and a folding curved surface extending from a distal end of the inclined surface on the ink ejection port side and curved more steeply than the inclined surface in a direction away from the shaft-like solvent.

According to the eleventh aspect, by providing the folding curved surface on the second electrode plate, the flow direction of the air jetted toward the second electrode plate can be guided in a direction away from the shaft-like solvent. As a result, the flow direction of the solvent carried along the flow of the air can also be guided in a direction away from the shaft-like solvent. As a result, leakage of the solvent from the ink ejection port is suppressed, and eventually, the convenience of the inkjet recording apparatus is enhanced.

Furthermore, according to a twelfth aspect of the present disclosure, the inkjet recording apparatus may further include a controller that accommodates the ink supply unit, the solvent supply unit, and the control unit therein, the controller may further include an air generation unit that generates air jetted from the air jetting unit, and the assist unit may include a control valve for controlling ejection of the air generated by the air generation unit.

According to the twelfth aspect, by arranging the control valve in the print head and arranging the air generation unit in the controller, the print head can be made compact by the amount of the print head excluding the air generation unit. Accordingly, the convenience of the inkjet recording apparatus can be enhanced.

Furthermore, according to a thirteenth aspect of the present disclosure, the air generation unit may include, in the controller, an air dryer that generates dry air by drying the air.

In order to promote blowing of the solvent by the air or realize expansion of the cleaning area by atomization of the air, it is conceivable to generate higher pressure air. However, when the air is increased in pressure by the air generation unit in the controller, dew condensation may occur inside the controller.

On the other hand, according to the thirteenth aspect, the air generation unit generates dry air by the air dryer. By configuring to generate the dry air, even if the air generation unit is arranged in the controller, the generation of dew condensation can be suppressed.

Furthermore, according to a fourteenth aspect of the present disclosure, the inkjet recording apparatus may further include a pressure sensor that is arranged on a way from the air dryer to the assist unit and detects blockage of air.

According to the fourteenth aspect, it is possible to detect blockage of the dry air after passing through the air dryer. Accordingly, the convenience of the inkjet recording apparatus can be enhanced.

Furthermore, according to a fifteenth aspect of the present disclosure, the print head may include an ink ejection port for ejecting ink deflected by the deflection electrode to the outside, and a shutter for opening and closing the ink ejection port.

According to the fifteenth aspect, by providing the shutter that opens and closes the ink ejection port, it is possible to suppress the solvent from leaking from the ink ejection port, and eventually, it is possible to enhance the convenience of the inkjet recording apparatus.

Furthermore, according to a sixteenth aspect of the present disclosure, before the assist by the assist unit is performed, the control unit may operate the shutter to close the ink ejection port.

According to the sixteenth aspect, by closing the ink ejection port before the start of the assist, the leakage of the solvent from the ink ejection port can be more reliably suppressed, and eventually, the convenience of the inkjet recording apparatus can be enhanced.

Furthermore, according to a seventeenth aspect of the present disclosure, the inkjet recording apparatus may further include a drying unit that dries an inside of the print head when the shutter closes the ink ejection port.

According to the seventeenth aspect, by drying the inside of the print head in a state where the ink ejection port is closed, the solvent leakage from the ink ejection port can be more reliably suppressed, and eventually, the convenience of the inkjet recording apparatus can be enhanced.

Furthermore, according to an eighteenth aspect of the present disclosure, the control unit may execute a drying treatment for drying the inside of the print head by causing the assist unit to execute assist when a solvent is not supplied from the solvent supply unit.

According to the eighteenth aspect, the components inside the print head can be dried by blowing air to the components or bringing the contact portion into contact with the components when the solvent is not supplied. Accordingly, the convenience of the inkjet recording apparatus can be enhanced.

Furthermore, according to a nineteenth aspect of the present disclosure, the control unit may repeatedly and alternately perform a cleaning treatment of cleaning the component with a solvent supplied from the solvent supply unit and the drying treatment by causing the assist unit to perform assist while turning on and off solvent supply from the solvent supply unit.

According to the nineteenth aspect, by alternately and repeatedly performing the cleaning treatment and the drying treatment, head cleaning can be performed while drying the solvent each time. Thus, the solvent leakage can be more reliably suppressed, and the convenience of the inkjet recording apparatus can be enhanced.

A twentieth aspect of the present disclosure relates to an inkjet recording system. An inkjet recording system includes: a continuous inkjet recording apparatus including: a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside; an ink supply unit that supplies ink to the print head; a solvent supply unit that supplies a solvent to the print head; and a control unit that controls ink supply from the ink supply unit to the print head, and controls solvent supply from the solvent supply unit to the print head, printing being performed by causing the ink ejected from the print head to land on a printing target object; and a cleaning apparatus mounted to the print head and including an assist unit that assists cleaning when cleaning a component accommodated inside the print head with a solvent supplied from the solvent supply unit.

According to the twentieth aspect, the solvent consumption amount in the head cleaning can be reduced, and the convenience of the inkjet recording apparatus can be enhanced.

Furthermore, according to another aspect of the present disclosure, the inkjet recording apparatus may further include a suction unit that sucks and exhausts air in an internal space of the print head.

According to this aspect, by providing the suction unit in the inkjet recording apparatus, the internal space of the print head can be dried and the volatilized solvent can be discharged. Accordingly, the convenience of the inkjet recording apparatus can be enhanced.

Furthermore, according to another aspect of the present disclosure, the inkjet recording apparatus may further include a posture sensor that detects a posture of the print head, and the control unit may change the cleaning sequence on the basis of a detection signal of the posture sensor.

According to this aspect, the convenience of the inkjet recording apparatus can be enhanced by changing the cleaning sequence according to the posture of the print head.

Furthermore, according to another aspect of the present disclosure, the components to be cleaned with the solvent supplied from the solvent supply unit may include at least one of the gutter, the nozzle, and the deflection electrode.

As described above, according to the present disclosure, the solvent consumption amount in the head cleaning can be reduced, and the convenience of the inkjet recording apparatus can be enhanced.

### BRIEF DESCRIPTION OF THE DRAWINGS

FIG. 1 is a diagram illustrating an overall configuration of an inkjet recording system;

FIG. 2 is a block diagram illustrating a schematic configuration of an inkjet recording apparatus;

FIG. 3 is a diagram illustrating a schematic configuration of a print head;

FIG. 4A is a diagram illustrating a schematic configuration of the print head;

FIG. 4B is a diagram illustrating the schematic configuration of the print head;

FIG. 5 is a diagram illustrating paths of ink and a solvent in an inkjet recording apparatus;

FIG. 6 is a diagram illustrating an overall configuration of an assist module;

FIG. 7 is a perspective view illustrating an internal structure of the print head;

FIG. 8 is a flowchart illustrating a process related to necessity determination of head cleaning;

FIG. 9 is a flowchart illustrating a specific process of the head cleaning;

FIG. 10A is a diagram corresponding to FIG. 4A, illustrating a first modification of the inkjet recording system;

FIG. 10B is a diagram corresponding to FIG. 4B, illustrating the first modification of the inkjet recording system;

FIG. 11 is a diagram illustrating an internal structure of a print head according to the first modification;

FIG. 12 is a diagram corresponding to FIG. 4A, illustrating a second modification of the inkjet recording system;

FIG. 13A is a diagram illustrating an operation of an assist unit according to a second modification;

FIG. 13B is a diagram illustrating the operation of the assist unit according to the second modification;

FIG. 14 is a diagram corresponding to FIG. 1, illustrating a third modification of the inkjet recording system;

FIG. 15 is a diagram corresponding to FIG. 4A, illustrating the third modification of the inkjet recording system; and

FIG. 16 is a flow path diagram obtained by extracting elements related to cleaning of the print head 1 from FIG. 5.

### DETAILED DESCRIPTION

Hereinafter, embodiments of the present disclosure will be described with reference to the drawings. Note that the following description is an example.

That is, in the present specification, an industrial inkjet printer will be described as an example of an inkjet recording apparatus, but the technology disclosed herein can be applied to a general device configured to cause particulate ink to fly and land on a print object such as a workpiece regardless of the names of the inkjet recording apparatus and the industrial inkjet printer.

Furthermore, in the present specification, printing by the inkjet recording apparatus will be described, but the "printing" referred to herein includes all processing processes to which inkjet is applied, such as printing of characters and marking of figures.

### Overall Configuration

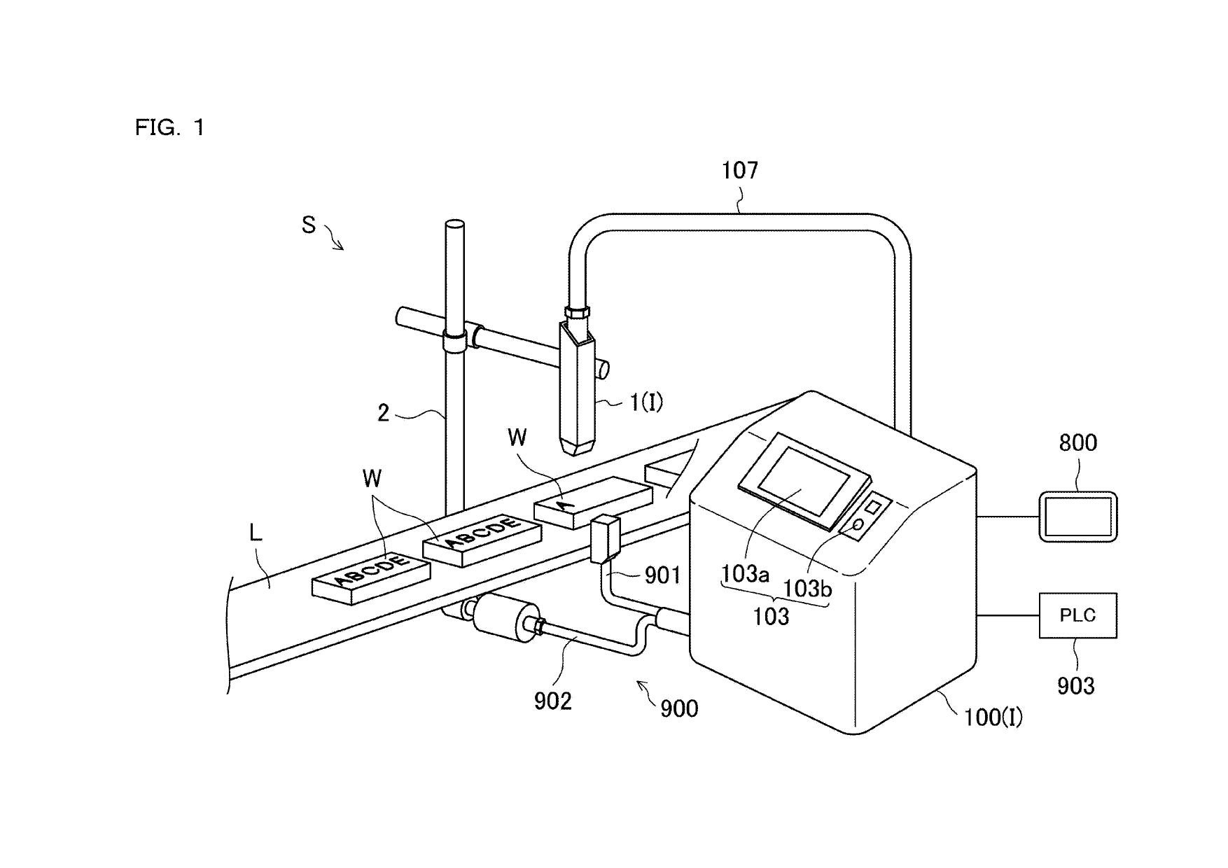

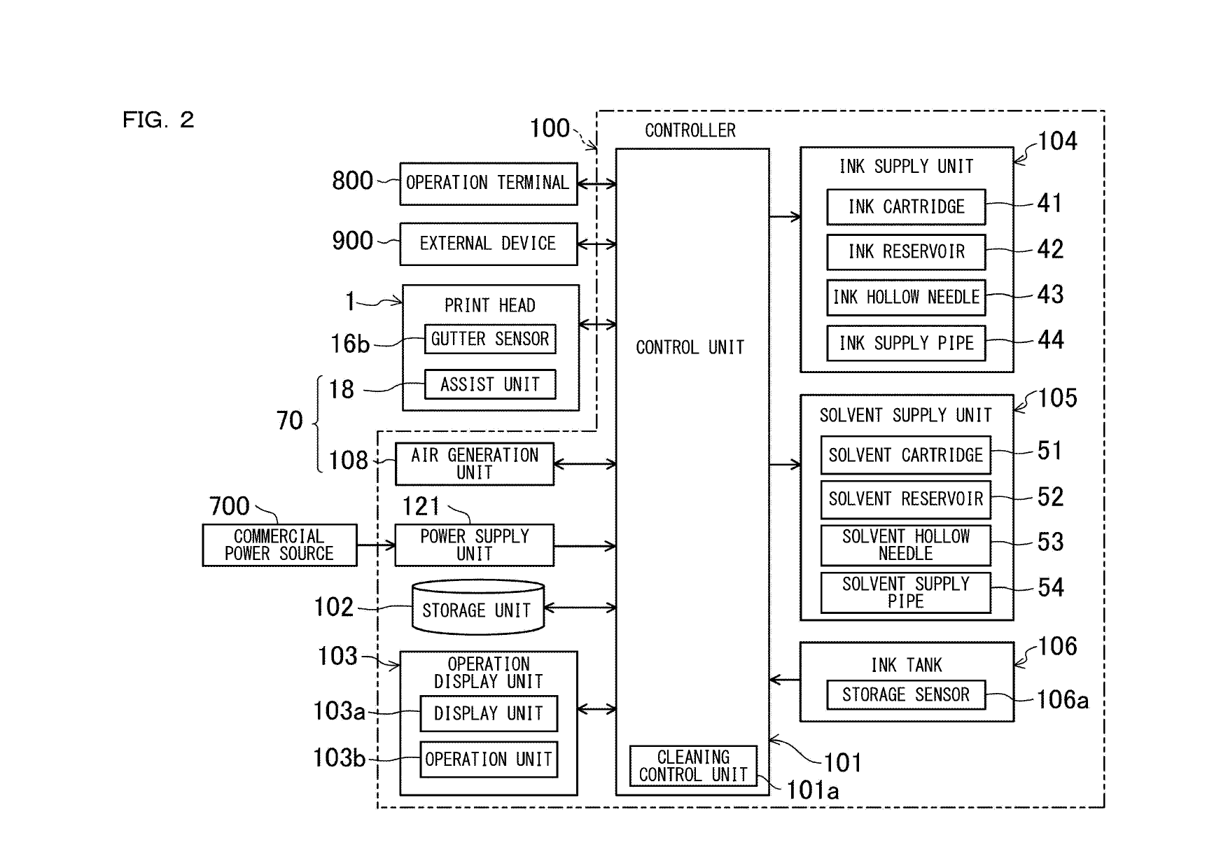

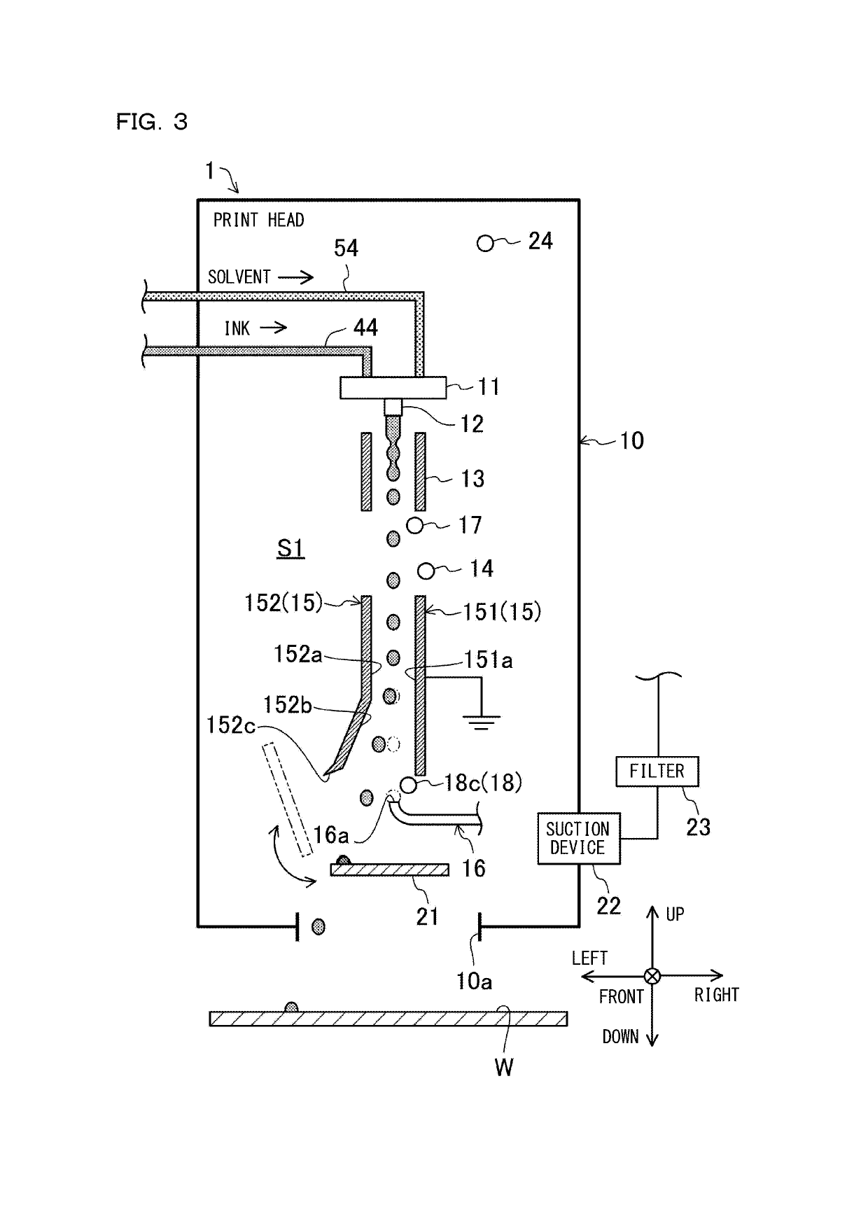

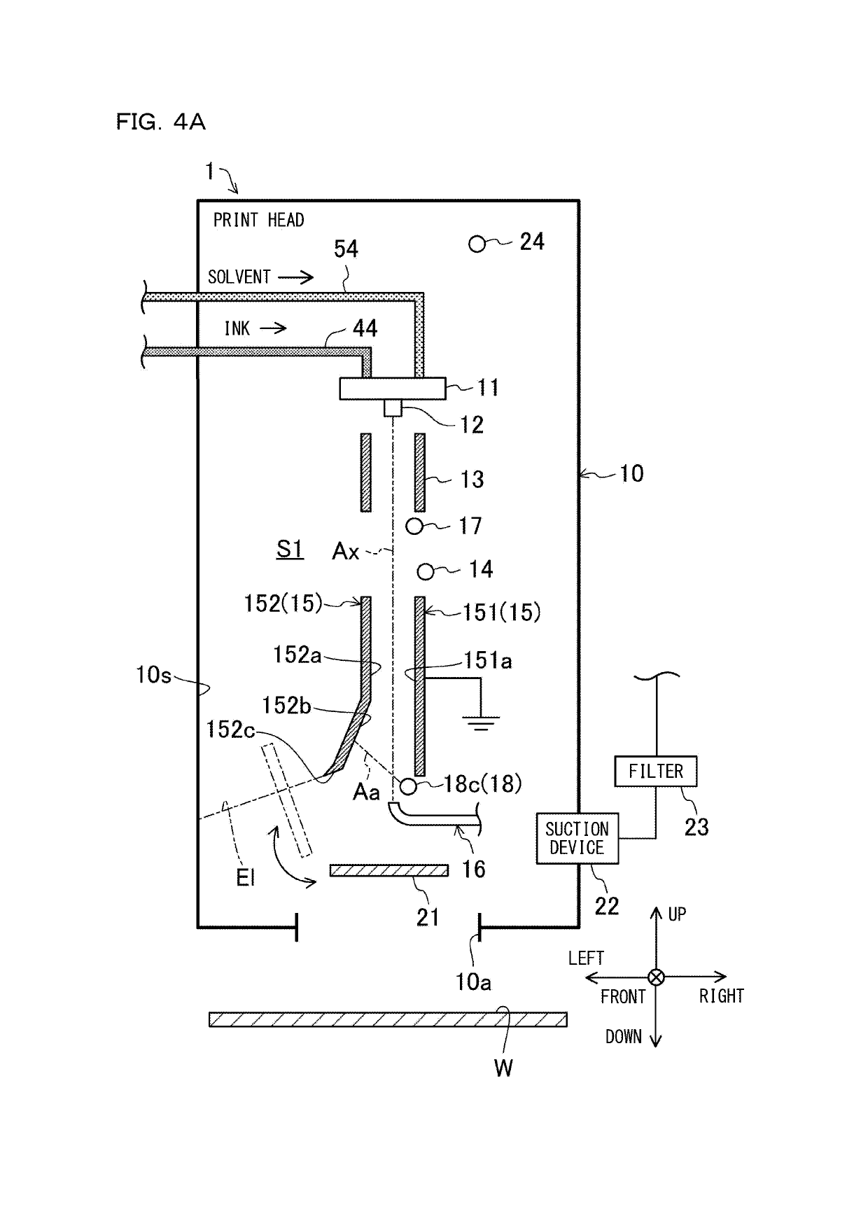

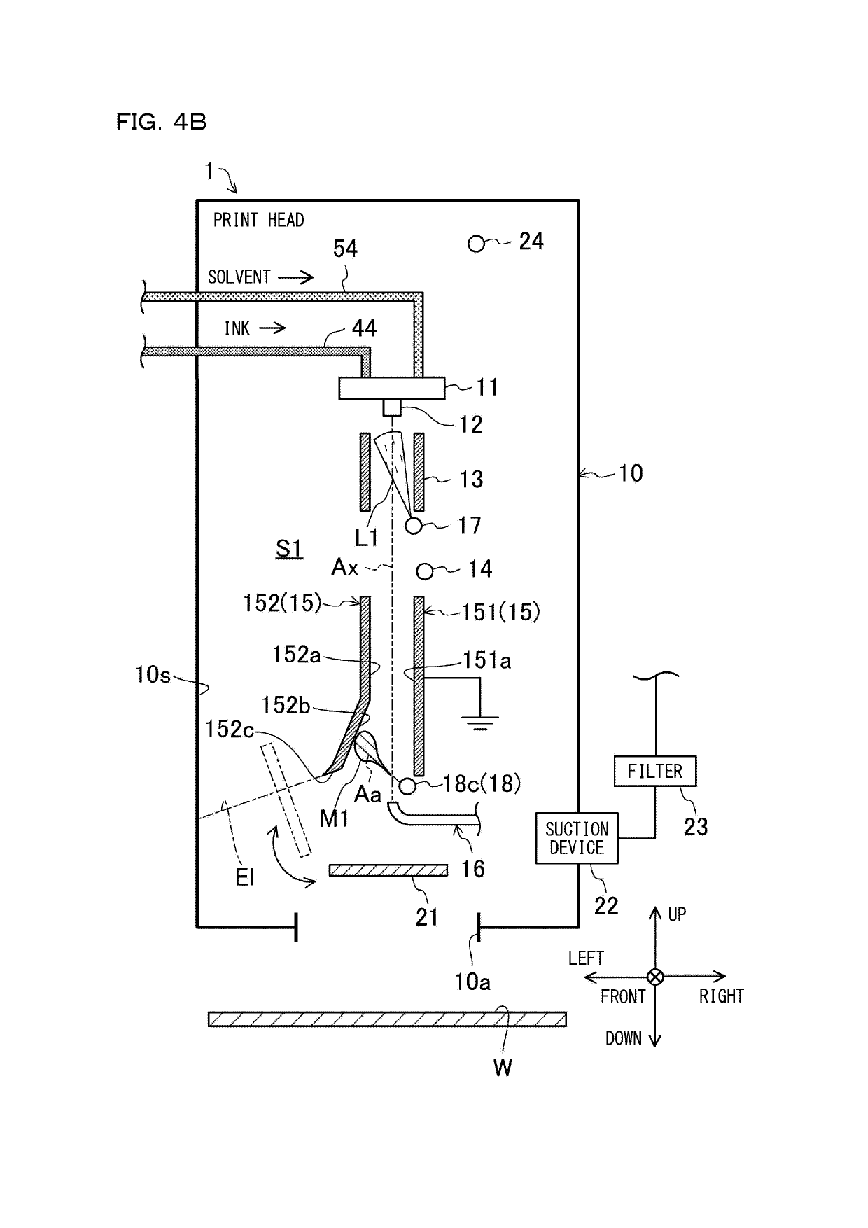

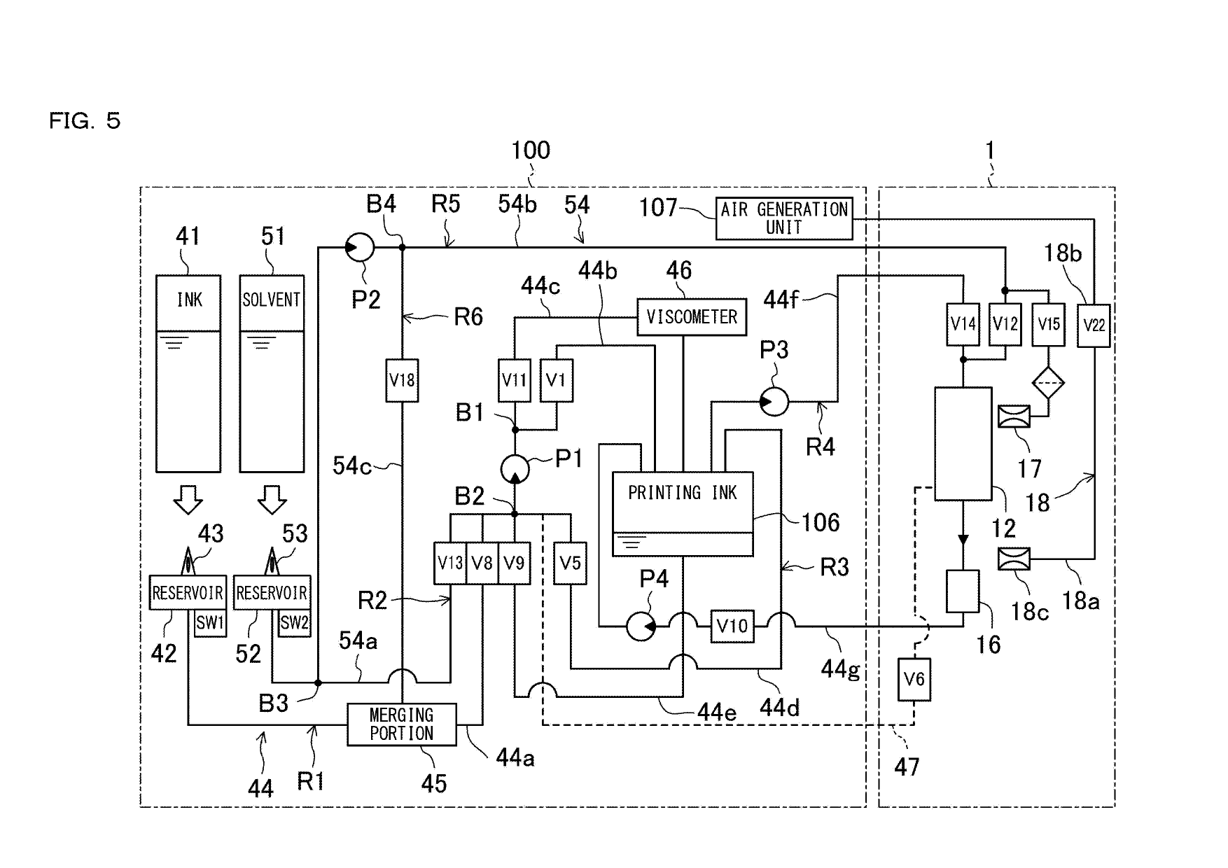

FIG. 1 is a diagram illustrating an overall configuration of an inkjet recording system S. FIG. 2 is a diagram illustrating a schematic configuration of an inkjet recording apparatus I, and FIGS. 3, 4A, and 4B are diagrams illustrating a schematic configuration of a print head 1 in the inkjet recording apparatus I. FIG. 5 is a diagram illustrating paths of ink and a solvent in the inkjet recording apparatus I.

An inkjet recording system S exemplified in FIG. 1 is installed in a conveyance line L in a factory or the like, for example, and is configured to sequentially perform printing on each print object W flowing through the conveyance line L. Note that the application target of the present disclosure is not limited to the inkjet recording system S. The present invention can be applied to a printing system using a method other than the automatic method. The conveyance line L can be configured by, for example, a belt conveyor or the like. The term "print object" may be referred to as a "printing target object" in the following description.

Specifically, the inkjet recording system S includes an inkjet recording apparatus I that performs printing by landing particulate ink (ink particles) on the print object W, and an operation terminal 800 and an external device 900 connected to the inkjet recording apparatus I. Note that the operation terminal 800 and the external device 900 are not essential.

The inkjet recording apparatus I exemplified in FIGS. 1 to 3 includes the print head 1 that ejects ink particles from the nozzles 12 and causes the ink particles to land on the print object W, and a controller 100 that supplies a control signal, ink, and a solvent to the print head 1. The controller 100 supplies a control signal to the print head 1 to control the locus of the ink particles. Thus, the landing position of the ink particles on the print object W is adjusted, and desired printing is realized. The print head 1 is fixed at a predetermined position by a support member 2 or the like.

The inkjet recording apparatus I is a continuous inkjet recording apparatus (continuous inkjet printer: CIJ). That is, in order to prevent clogging (in particular, clogging of the nozzle 12) and the like due to volatilization of the ink, even when the inkjet recording apparatus I is not executing printing, the ink always circulates inside the inkjet recording apparatus I as long as the inkjet recording apparatus I is in an operating state. By adopting the continuous type, a quick-drying ink can be used without causing clogging by the ink.

Furthermore, the inkjet recording apparatus I according to the present embodiment can adjust the concentration (viscosity) of the ink by mixing the solvent and the ink. Furthermore, the inkjet recording apparatus I can clean each unit in the print head 1 such as the nozzle 12 by sending out a solvent to the print head 1. The solvent used for cleaning can be recovered as necessary and reused to adjust the concentration (viscosity) of the ink.

In order to realize the circulation of the ink, the print head 1 includes a gutter 16 that recovers the ink or the solvent ejected from the nozzle 12 in addition to the nozzle 12 that ejects the ink or the solvent (see FIG. 3). The ink or solvent fed from the controller 100 to the print head 1 is ejected from the nozzle 12 and collected by the gutter 16. The ink or solvent thus recovered is sent back to the controller 100 to be reused. By repeating such steps, the ink can be circulated.

On the other hand, the operation terminal 800 includes, for example, a central processing unit (CPU) and a storage device, and is connected to the controller 100. The operation terminal 800 defines print settings and functions as a terminal for indicating information related to printing to the user.

The print settings set by the operation terminal 800 are output to the controller 100 and stored in the storage unit 102. In addition to the storage unit 102 of the controller 100 or instead of the storage unit 102, the operation terminal 800 may store the print settings.

Note that the print setting according to the present embodiment may include conditions and parameters related to head cleaning to be described later, in addition to the contents of character strings and the like to be printed.

Note that the operation terminal 800 can be incorporated in and integrated with the controller 100, for example. In this case, the term "control unit" or the like is used instead of the term "operation terminal".

The external device 900 is connected to the controller 100 as necessary. In the example illustrated in FIGS. 1 and 2, a workpiece detection sensor 901, a conveyance speed sensor 902, and a programmable logic controller (PLC) 903 are provided as the external device 900.

Specifically, the workpiece detection sensor 901 detects the presence or absence of the print object W on the conveyance line L, and outputs a signal (detection signal) indicating the detection result to the controller 100. The detection signal output from the workpiece detection sensor 901 functions as a trigger (print trigger) for starting printing.

The conveyance speed sensor 902 includes, for example, a rotary encoder, and can detect the conveyance speed of the print object W. The conveyance speed sensor 902 outputs a signal (detection signal) indicating the detection result to the controller 100. The controller 100 controls timing and the like of ejecting the ink particles from the print head 1 based on the detection signal input from the conveyance speed sensor 902.

As exemplified in FIG. 2, the PLC 903 is electrically connected to the controller 100. The PLC 903 is used to control the inkjet recording system S according to a predetermined sequence.

In addition to the devices and apparatuses described above, a device for performing operation and control, a computer for performing other various processes, a storage device, a peripheral device, and the like can be connected to the inkjet recording apparatus I. The connection method in this case may be either wired connection or wireless connection.

### Controller 100

The controller 100 is configured to electrically control the print head 1 and supply printing ink and a solvent for diluting the ink to the print head 1.

Specifically, the controller 100 according to the present embodiment includes, as components related to electrical control, a storage unit 102 that stores the above-described print settings, a control unit 101 that controls the controller 100 and each unit of the print head 1, an operation display unit 103 that receives an operation by a user and displays information to the user, and a power supply unit 121 that guides power supplied from the outside to the control unit 101.

The controller 100 also includes an ink supply unit 104, a solvent supply unit 105, and an ink tank 106 as components related to supply of ink and the like. These components are in direct or indirect fluid connection with the print head 1. In at least the present embodiment, the controller 100 accommodates the ink supply unit 104, the solvent supply unit 105, and the control unit 101 therein.

The ink supply unit 104 includes an ink reservoir 42 that removably receives an ink cartridge 41 in which ink is stored. The ink supply unit 104 supplies ink to the print head 1.

Meanwhile, the solvent supply unit 105 includes a solvent reservoir 52 that removably receives a solvent cartridge 51 in which a solvent is stored. The solvent supply unit 105 supplies ink to the print head 1.

Further, the ink tank 106 stores the ink from the ink cartridge 41 received in the ink reservoir 42 and the solvent from the solvent cartridge 51 received in the solvent reservoir 52 as printing ink. The "printing ink" herein means a mixture of a solvent and ink (for example, ink whose concentration is adjusted by a solvent).

Then, the print head 1 performs printing with the printing ink from the ink tank 106. The print head 1 also cleans each unit in the print head 1, such as the nozzle 12, with the solvent supplied from the solvent supply unit 105 while bypassing the ink tank 106.

In addition, the controller 100 according to the present embodiment includes an air generation unit 108 as an element related to the cleaning treatment of the print head 1. The air generation unit 108 is accommodated in the controller 100. Details of the air generation unit 108 will be described later. In addition, the cleaning treatment of the print head 1 here refers to a process of cleaning the inside of the print head 1, in particular, components accommodated inside the print head 1 with a solvent. Hereinafter, this cleaning treatment is also referred to as "head cleaning".

The head cleaning is assisted by an assist module 70 of the inkjet recording system S. The assist module 70 according to the present embodiment includes the air generation unit 108 of the controller 100 and the assist unit 18 of the print head 1. Details of the air generation unit 108 and the assist unit 18 will be described later.

Note that the control unit 101, the ink supply unit 104, and the solvent supply unit 105 may be configured as separate units. The storage unit 102 may also be configured as a separate unit from the ink supply unit 104 and the solvent supply unit 105. The operation display unit 103 may also be configured as a separate unit from the ink supply unit 104 and the solvent supply unit 105. Also in these cases, the components can be combined into the controller 100.

Furthermore, considering the ink supply unit 104 and the ink tank 106 as independent components is merely a classification for convenience. From the viewpoint of being related to the supply of ink, the ink tank 106 may be regarded as an element of the ink supply unit 104.

(Storage Unit 102)

The storage unit 102 is configured to store print settings set via the operation display unit 103 or the operation terminal 800 described later, and output the stored print settings to the control unit 101 on the basis of a control signal from the outside.

Specifically, the storage unit 102 is configured using a volatile memory, a nonvolatile memory, a solid state drive (SSD), a hard disk drive (HDD), or the like, and can temporarily or continuously store information indicating print settings. When the operation terminal 800 is incorporated in the controller 100, the operation terminal 800 may also serve as the storage unit 102.

(Control Unit 101)

The control unit 101 is a processing unit that controls ink supply from the ink supply unit 104 to the print head 1 and controls solvent supply from the solvent supply unit 105 to the print head 1.

Specifically, the control unit 101 controls at least the ink supply unit 104 and the solvent supply unit 105 in the controller 100 and the nozzle 12, the charging electrode 13, and the deflection electrode 15 in the print head 1 based on the print settings stored in the storage unit 102. By controlling each unit by the control unit 101, printing on the printing target object W is performed at a predetermined timing.

More specifically, the control unit 101 includes, for example, a CPU, a memory, an input/output bus, and the like, and generates a control signal on the basis of a signal indicating information input via the operation display unit 103 or the operation terminal 800 and a signal indicating a print setting read from the storage unit 102. The control unit 101 outputs the control signal thus generated to the controller 100 and each unit of the inkjet recording apparatus I to control printing on the print object W.

For example, when printing is performed on the printing target object W, the control unit 101 reads the print content on the printing target object W stored in the storage unit 102 and generates a control signal based on the print content. Then, the control unit 101 outputs the control signal to the charging electrode 13 to set the flying direction of the ink particles so as to realize the landing position corresponding to the print content.

Other Functional Elements in the Control Unit 101

In addition, the control unit 101 according to the present embodiment includes a cleaning control unit 101a exemplified in FIG. 2 as a functional element that executes a process related to head cleaning. Details of the cleaning control unit 101a will be described later.

(Operation Display Unit 103)

As illustrated in FIG. 1, the operation display unit 103 includes a display unit 103a that displays information to the user and an operation unit 103b that receives an operation by the user. The operation display unit 103 can be provided in, for example, a housing or the like constituting the controller 100, but may be configured separately from the housing and set at a location different from the housing. When the operation terminal 800 is incorporated in the controller 100, the operation terminal 800 may also serve as the operation display unit 103.

The display unit 103a displays various types of information related to the inkjet recording apparatus I. The display unit 103a includes, for example, a liquid crystal display panel, an organic EL display panel, or the like, and changes a display mode in response to a control signal from the control unit 101. The display unit 103a can display a user interface for operating each unit of the inkjet recording system S, a user interface for setting print settings, and a user interface related to head cleaning.

The operation unit 103b includes, for example, a touch operation panel, a button, a switch, and the like. When the user operates the operation unit 103b, information (operation information) corresponding to the operation input is input to the control unit 101, and the control unit 101 can detect what operation has been performed. For example, by operating the operation unit 103b, it is possible to switch the power ON/OFF and the like of the inkjet recording apparatus I, and to perform various settings, input information, and the like.

The operation display unit 103 can also set print settings similarly to the operation terminal 800 described above. The print settings set by the operation display unit 103 are output to the controller 100 and stored in the storage unit 102. In the following description, it is assumed that the user operates the operation display unit 103, but the operation terminal 800 may be used instead of the operation display unit 103.

(Ink Supply Unit 104)

The ink supply unit 104 supplies the ink from the ink cartridge 41 to the nozzles 12 of the print head 1 as printing ink. At this time, the ink from the ink supply unit 104 is supplied to the print head 1 via the ink tank 106.

Specifically, the ink supply unit 104 according to the present embodiment includes, as main components, the ink cartridge 41 and the ink reservoir 42 described above, an ink hollow needle 43 as a hollow needle, and an ink supply pipe 44. The ink hollow needle 43 fluidly connects the ink cartridge 41 and the ink supply pipe 44. The ink supply pipe 44 fluidly connects the ink cartridge 41 and the print head 1 via the ink hollow needle 43. The ink tank 106 is arranged in the middle of the ink supply pipe 44 from the ink hollow needle 43 to the print head 1.

Among them, the ink cartridge 41 stores ink. The ink reservoir 42 removably receives the ink cartridge 41. By replacing the ink cartridge 41 with respect to the ink reservoir 42, ink can be replenished to the ink tank 106. That is, the inkjet recording apparatus I according to the present embodiment is configured as a so-called "cartridge type" inkjet printer.

As illustrated only in FIG. 5, the ink reservoir 42 is provided with a first attachment sensor SW1 that detects attachment of the ink cartridge 41 or the solvent cartridge 51 to the ink reservoir 42.

The ink hollow needle 43 accesses the ink in the ink cartridge 41 when the ink reservoir 42 receives the ink cartridge 41 (when the ink cartridge 41 is mounted to the ink reservoir 42).

The ink supply pipe 44 constitutes a path for supplying printing ink to the print head 1. Ink can be circulated between the print head 1 and the controller 100 by a path constituted by the ink supply pipe 44.

As described later, the ink supply pipe 44 is provided with a plurality of on-off valves including a first valve V1 and a plurality of pumps including a first pump P1. Among these, each on-off valve is constituted by an electromagnetic valve. Each on-off valve can open and close in response to a control signal output from the control unit 101 to control the flow of ink. On the other hand, each pump receives the control signal output from the control unit 101 to pressure-feed the ink, and can control the flow of the ink similarly to the on-off valve. At least a part of the opening and closing (for example, the first valve V1, an eighth valve V8, an 11th valve V11, and an 18th valve V18 in FIG. 5) may be a manual cock instead of the electromagnetic valve.

(Solvent Supply Unit 105)

The solvent supply unit 105 supplies the solvent from the solvent cartridge 51 to the ink tank 106 similarly to the ink, or supplies the solvent alone to the nozzle 12. The former solvent forms a printing ink together with the ink by adjusting the density of the ink, and is supplied to the print head 1.

Here, in a case of configuring the printing ink together with the ink (that is, when printing is performed on the print head 1), the solvent from the solvent supply unit 105 is guided to the nozzle 12 through the ink tank 106. On the other hand, when supplied as a solvent alone (for example, when head cleaning to be described later is performed), the solvent from the solvent supply unit 105 is guided to the nozzle 12 without passing through the ink tank 106.

Specifically, the solvent supply unit 105 according to the present embodiment includes, as main components, the solvent cartridge 51 and the solvent reservoir 52 described above, a solvent hollow needle 53, and a solvent supply pipe 54. The solvent hollow needle 53 fluidly connects the solvent cartridge 51 and the solvent supply pipe 54. The solvent supply pipe 54 fluidly connects the solvent cartridge 51 to the print head 1 and to the ink tank 106 via the solvent hollow needle 53.

Among them, a solvent is stored in the solvent cartridge 51. The solvent reservoir 52 removably receives the solvent cartridge 51. By replacing the solvent cartridge 51 with respect to the solvent reservoir 52, it is possible to replenish the solvent for concentration adjustment and the cleaning solvent. That is, the inkjet recording apparatus I according to the present embodiment is also configured as a "cartridge type" inkjet printer for the solvent.

As illustrated only in FIG. 5, the solvent reservoir 52 is provided with a second attachment sensor SW2 that detects attachment of the solvent cartridge 51 or the ink cartridge 41 to the solvent reservoir 52.

The solvent hollow needle 53 accesses the solvent in the solvent cartridge 51 when the solvent reservoir 52 receives the solvent cartridge 51 (when the solvent cartridge 51 is mounted to the solvent reservoir 52).

The solvent supply pipe 54 constitutes a path for supplying a solvent to the ink tank 106 or supplying a solvent to the print head 1 without interposing the ink tank 106. By these paths, the printing ink can be generated from the ink and the solvent, and the print head 1 can be cleaned with the solvent.

Note that the classification of the ink supply pipe 44 and the solvent supply pipe 54 is merely a classification for convenience made to simplify the description. The ink supply pipe 44 and the solvent supply pipe 54 are substantially inseparable because they are connected to each other or one serves as the other.

As described later, the solvent supply pipe 54 is provided with a plurality of on-off valves including a 12th valve V12 and a plurality of pumps including a second pump P2. Among these, each on-off valve is constituted by an electromagnetic valve. Each on-off valve can open and close in response to a control signal output from the control unit 101 to control the flow of the solvent. On the other hand, each pump receives a control signal output from the control unit 101 to pressure-feed the solvent, and can control the flow of the solvent similarly to the electromagnetic valve. As described above, a manual cock may be used instead of the electromagnetic valve.

(Ink Tank 106)

The ink tank 106 is configured to store ink from the ink cartridge 41 and a solvent from the solvent cartridge 51. Specifically, the ink tank 106 is constituted by a container that stores ink whose concentration (viscosity) is adjusted by a solvent, that is, a mixture of ink and solvent.

The printing ink supplied from the ink tank 106 to the nozzles 12 lands on the surface of the print object W at the time of printing, and is collected by the gutter 16 and sent back to the ink tank 106 at the time of non-printing. This achieves circulation of the printing ink.

Furthermore, the solvent supplied to the nozzle 12 for cleaning is also collected by the gutter 16, and then sent to the ink tank 106 via, for example, a conditioning tank (not illustrated) dedicated to the solvent, and can be reused for the concentration adjustment of the ink.

The ink tank 106 is provided with a storage sensor 106a for detecting a liquid level (so-called liquid surface level) in the tank. The storage sensor 106a is electrically connected to the control unit 101, and inputs a detection signal thereof to the controller 100. The storage sensor 106a may be an electrode type level sensor, a float type level sensor, or a capacitance type level sensor.

(Power Supply Unit 121)

The power supply unit 121 is interposed between a commercial power source 700 and the control unit 101, and can relay power supplied from the commercial power source 700 and supply the power to the control unit 101.

### Other Components

The controller 100 is provided with a connection cable 107 in which a power supply wire for transmitting and receiving a control signal, a tube (specifically, the tube constituting the ink supply pipe 44) for transmitting and receiving ink, and a tube (specifically, a tube constituting the solvent supply pipe 54) for transmitting and receiving a solvent are covered in a bundle. This connection cable 107 is flexible and is connected to the upper end of the print head 1 (see FIG. 1). The controller 100 and the print head 1 are electrically and fluidly connected via this connection cable 107.

### Print Head 1

The print head 1 ejects ink (printing ink) whose density has been adjusted based on a control signal, ink, and solvent supplied from the controller 100 as particulate ink (hereinafter, also referred to as "ink particles"). The print head 1 can perform printing on the print object W by deflecting the flying direction of the ejected ink particles and causing the deflected ink particles to land on the surface of the print object W. The details of printing at that time are in accordance with the printing setting described above. The print head 1 can sequentially perform printing on each of the print objects W according to the print setting.

Specifically, as illustrated in FIG. 3, the print head 1 according to the present embodiment includes a pressurizer 11, a nozzle 12, a charging electrode 13, a deflection electrode 15, a gutter 16, a cleaning nozzle 17, a shutter 21, a suction device 22, a filter 23, and a posture sensor 24. The pressurizer 11 pressurizes the printing ink to form a particulate ink. The nozzle 12 ejects particulate ink. The charging electrode 13 charges the particulate ink ejected from the nozzle 12. The deflection electrode 15 deflects flight deflection of the printing ink charged by the charging electrode 13. The gutter 16 collects the printing ink not deflected by the deflection electrode 15 or the solvent ejected from the nozzle 12. Note that the shutter 21, the suction device 22, the filter 23, and the posture sensor 24 are not essential.

In addition, as elements related to acquisition of various parameter values, the print head 1 includes a charge detection sensor 14 that monitors a charge state of the printing ink, and a gutter sensor 16b that detects whether or not the ink is in the gutter 16.

The print head 1 accommodates the pressurizer 11, the nozzle 12, the charging electrode 13, the charge detection sensor 14, the deflection electrode 15, the gutter 16, and the cleaning nozzle 17 therein, and ejects the printing ink deflected by the deflection electrode 15 to the outside. Then, the inkjet recording apparatus I according to the present embodiment performs printing by causing the ink deflected by the deflection electrode 15 to land on the printing target object.

Specifically, the print head 1 includes a housing 10 that accommodates the pressurizer 11, the nozzle 12, the charging electrode 13, the charge detection sensor 14, the deflection electrode 15, the gutter 16, the gutter sensor 16b, and the cleaning nozzle 17 therein and defines the flying space S1 of the ink particles. The print head 1 can eject the ink particles deflected by the deflection electrode 15 to the outside of the housing 10 through the flying space S1.

As exemplified in FIG. 3, the housing 10 extends in the up-down direction on the drawing sheet. In the following description, the longitudinal direction of the housing 10 is simply referred to as an "up-down direction", while two directions orthogonal to the up-down direction are referred to as a "front-rear direction" and a "left-right direction", respectively. In other drawings, directions corresponding to these directions are referred to as an “up-down direction", a "front-rear direction", and a "left-right direction", respectively.

Here, "upper" refers to the upper side of the drawing sheet of FIG. 3, and "lower" refers to the lower side of the drawing sheet. Similarly, "front" refers to the front side (specifically, the left front side) of the drawing sheet of FIG. 3, "rear" refers to the back side (specifically, the right back side) of the drawing sheet, "left" refers to the left side (specifically, the upper left side) of the drawing sheet, and "right" refers to the right side "specifically, the lower right side" of the drawing sheet. In other drawings, those corresponding to these are referred to as "upper", "lower", "front", "rear", "left", and "right", respectively.

Note that the print head 1 does not necessarily have its up-down direction along the vertical direction (gravity direction). The print head 1 may also be in a posture with its up-down direction along the horizontal direction.

Further, the print head 1 has an ink ejection port 10a for ejecting the ink deflected by the deflection electrode 15 to the outside. As illustrated in FIG. 3, the ink ejection port 10a opens on the lower surface of the housing 10 forming the outer shape of the print head 1. Hereinafter, the ink ejection port 10a is also simply referred to as an ejection port 10a. The ink particles are ejected from the ejection port 10a toward the lower side of the housing 10.

As illustrated in FIG. 1, the print head 1 at the time of printing is supported by, for example, the support member 2. The print head 1 in a state of being supported by the support member 2 is arranged such that the ejection port 10a faces the print surface of the print object W from the upward direction. This place is an example of an installation place of the print head 1 when printing is performed by the inkjet recording apparatus I.

Hereinafter, each unit constituting the print head 1 will be described in order. In the following description, the "up-down direction" refers to a direction along the vertical direction. For example, the upper side of the drawing sheet of FIG. 3 corresponds to the "upward direction", and the lower side of the ground in FIG. 3 corresponds to the "downward direction".

(Pressurizer 11)

As exemplified in FIG. 3, the pressurizer 11 is arranged near an upper end of the housing 10 in the flight space S1. The pressurizer 11 is configured to be supplied with printing ink from the ink tank 106 via the connection cable 107.

The pressurizer 11 pressurizes the ink liquid supplied from the ink tank 106. The ink pressurized by the pressurizer 11 is supplied to the nozzle 12. Although not illustrated, the pressurizer 11 according to the present embodiment is grounded.

(Nozzle 12)

The nozzle 12 is connected to a lower end of the pressurizer 11, and is arranged in a posture in which an opening end (printing ink) thereof faces downward. The nozzle 12 includes a piezoelectric element (for example, a piezo element) that applies vertical vibration to the ink, and applies the vertical vibration to the ink pressurized by the pressurizer 11 and then ejects the ink from the ejection port (opening end). Due to this vibration, the ink liquid ejected from the nozzle 12 is formed into particles after a predetermined time from the ejection timing.

Here, the printing ink ejected from the nozzle 12 without being applied vibration (without being vibrated) flows in a so-called "ink shaft" of a shaft shape. On the other hand, the printing ink ejected from the nozzle 12 to which vibration has been applied (which has been vibrated) has a shaft shape immediately after being ejected from the nozzle 12, but becomes a particle shape as being separated from the nozzle 12. The particle-formed printing ink drops as so-called "ink particles". The printing ink passes through the charging electrode 13 regardless of whether it is an ink shaft or ink particles. By ejecting the solvent alone from the nozzle 12, the solvent can flow in a shaft shape. Hereinafter, such a shaft-like solvent is also referred to as a "solvent shaft". The central axes of the ink shaft and the solvent shaft are as indicated by a two-dot chain line Ax in FIG. 4A.

When the nozzle 12 includes a piezoelectric element, particle formation of the ink can be controlled through a voltage (piezoelectric voltage) applied to the piezoelectric element. In the present embodiment, the controller 100 is configured to apply a controllable piezoelectric voltage to the piezoelectric element of the nozzle 12.

Note that the solvent supplied to clean the inside of the print head 1 sequentially passes through the pressurizer 11 and the nozzle 12 and is ejected from the distal end of the nozzle 12. The solvent thus ejected flows axially and passes through the charging electrode 13.

Furthermore, a suction path 47 illustrated in FIG. 5 is connected to the nozzle 12, for example, as a return path for releasing the pressure inside the print head 1 at the time of power-down of the inkjet recording apparatus I. The solvent can also be sucked from the nozzle 12 through the suction path 47.

(Charging Electrode 13)

As exemplified in FIG. 3, the charging electrode 13 includes a pair of metal plates having electrical conductivity, and is arranged below the nozzle 12. Here, the pair of metal plates constituting the charging electrode 13 is fixed to the housing 10 in a posture in which the longitudinal directions thereof are aligned with the up-down direction and in a posture in which the metal plates face each other in the horizontal direction. The interval between the pair of metal plates is set to be larger than the particle diameter of the ink ejected from the nozzle 12, and the printing ink ejected from the nozzle 12 passes between the pair of metal plates. Note that the metal plates constituting the charging electrode 13 need not be a pair.

A potential (positive potential) is applied to the charging electrode 13 at least when a printing operation is executed. As a result, a potential difference is generated between the pressurizer 11 and the charging electrode 13, and the ink particles passing through the charging electrode 13 can be charged. In order to charge each ink particle, the charging electrode 13 according to the present embodiment is arranged in the vicinity of a breakpoint where the printing ink ejected from the nozzle 12 is formed into particles.

Specifically, a pulse potential that can be controlled by the controller 100 is applied to the charging electrode 13. Here, when a relatively high voltage is applied to the charging electrode 13, the charge amount (magnitude of negative charge) of each ink particle becomes larger than when a lower voltage is applied. When the charge amount of each ink particle is large, the ink particle is greatly deflected by the deflection electrode 15 as compared with when the charge amount is small. The controller 100 can control the deflection amount of the ink particles by adjusting the magnitude of the pulse potential. The ink particles charged by the charging electrode 13 pass by the side of the charge detection sensor 14 and reach the deflection electrode 15.

In addition, the solvent ejected from the nozzle 12 passes through the side of the charge detection sensor 14 and reaches the deflection electrode 15 without being charged.

(Charge Detection Sensor 14)

As exemplified in FIG. 3, the charge detection sensor 14 is arranged below the charging electrode 13. Specifically, the charge detection sensor 14 is arranged below a metal plate (in the illustrated example, the metal plate on the right side of the drawing sheet) constituting the charging electrode 13 so as not to cross the locus when the ink particles fly. By arranging the charge detection sensor 14 in this manner, it is possible to avoid collision between the ink particles and the charge detection sensor 14.

In addition, the charge detection sensor 14 according to the present embodiment is connected to a circuit board provided inside the housing 10. The charge detection sensor 14 can detect the charged state (in particular, the charge amount of each ink particle) of the ink particles passing through the side. A detection result by the charge detection sensor 14 is output to the control unit 101 as a detection signal. Based on this detection signal, the control unit 101 can determine whether or not each ink particle is appropriately charged.

(Deflection Electrode 15)

As exemplified in FIG. 3, the deflection electrode 15 includes a pair of metal plates (so-called "counter electrodes") having electrical conductivity, and is arranged below the charging electrode 13 and the charge detection sensor 14. Here, the pair of metal plates is fixed to the housing 10 in a posture in which the longitudinal directions thereof are substantially along the up-down direction and in a posture in which the pair of metal plates face each other in the horizontal direction. The ink particles that have passed between the pair of metal plates constituting the charging electrode 13 pass between the pair of metal plates constituting the deflection electrode 15.

A voltage (hereinafter, this is also referred to as "deflection voltage") that can be controlled by the controller 100 is applied to the deflection electrode 15. As a result, a potential difference corresponding to the deflection voltage is generated between the pair of metal plates constituting the deflection electrode 15. Due to this potential difference, the flying direction of the ink particles can be deflected according to the charge amount of the ink particles. The flying direction of the ink particles can be deflected along the arrangement direction of the pair of metal plates constituting the deflection electrode 15.

That is, the flying direction of the ink particles can be controlled via the deflection voltage applied to each of the charging electrode 13 and the deflection electrode 15. The ink particles whose flying direction is controlled in this manner include those deflected by the deflection electrode 15 and those not deflected by the deflection electrode 15 (those not deflected). Among them, the ink particles deflected by the deflection electrode 15 are involved in printing of the printing target object W. The ink particles deflected by the deflection electrode 15 are ejected from the ejection port 10a provided on the lower surface of the housing 10, and land on the printing target object W.

On the other hand, the ink particles that are not deflected by the deflection electrode 15 are not involved in the printing of the print object W. Such ink particles, or the shaft-shaped printing ink that is not formed into particles in the first place, reach the inside of the gutter 16 as exemplified by the chain line in FIG. 3. Similarly, the solvent used for cleaning the nozzles 12 and the like in the print head 1 and having passed through the deflection electrode 15 also reaches the inside of the gutter 16.

Details of Deflection Electrode 15

Specifically, the deflection electrode 15 according to the present embodiment includes first and second electrode plates 151 and 152 facing each other. The first electrode plate 151 is grounded. The first electrode plate 151 can also be referred to as a ground electrode. A high voltage is applied to the second electrode plate 152.

The first electrode plate 151 faces the second electrode plate 152 with a space therebetween. The first electrode plate 151 has a first facing surface 151a. The first facing surface 151a extends in the up-down direction and faces the second electrode plate 152.

On the other hand, the second electrode plate 152 has a second facing surface 152a, an inclined surface 152b, and a folding curved surface 152c. The second facing surface 152a and the inclined surface 152b are continuous in the up-down direction from the nozzle 12 side toward the ejection port 10a side. The inclined surface 152b and the folding curved surface 152c are continuous in the up-down direction from the nozzle 12 side toward the ejection port 10a side.

The second facing surface 152a extends straight along the up-down direction. The second facing surface 152a extends in parallel with the first facing surface 151a.

The inclined surface 152b extends from a distal end of the second facing surface 152a on the ejection port 10a side. The inclined surface 152b is inclined in a direction away from the ink shaft or the solvent shaft, that is, in a direction extending along the up-down direction and away from the central axis Ax connecting the nozzle 12 and the gutter 16 (see FIG. 4A).

The folding curved surface 152c extends from a distal end of the inclined surface 152b on the ejection port 10a side. The folding curved surface 152c is more steeply bent than the inclined surface 152b in a direction away from the ink shaft or the solvent shaft, that is, in a direction extending along the up-down direction and away from the central axis Ax connecting the nozzle 12 and the gutter 16 (see FIG. 4A).

More specifically, as illustrated in FIG. 4A, an extended line El extending from a distal end (in particular, the distal end on the ejection port 10a side) of the folding curved surface 152c does not intersect the ejection port 10a but extends so as to intersect the side wall portion 10s of the housing 10 around the ejection port 10a.

(Gutter 16)

As exemplified in FIG. 3, the gutter 16 is configured by a curved pipe having an opening 16a facing upward, and is arranged below the deflection electrode 15. The gutter 16 according to the present embodiment can collect the printing ink that is not involved in printing of the print object W and the solvent (specifically, the solvent ejected from the nozzle 12) that has passed through the nozzle 12.

Specifically, in the present embodiment, the opening 16a of the gutter 16 and the opening end of the nozzle 12 are arranged to face each other, and the opening end of the nozzle 12 is located directly above the opening 16a of the gutter 16. With this arrangement, the fluid flowing along the vertical direction from the opening end of the nozzle 12 and the flying fluid can be received from the opening 16a of the gutter 16.

The gutter 16 is provided with a charge type or thermistor type gutter sensor 16b (see FIG. 3). The gutter sensor 16b can detect whether the printing ink is in the gutter 16, determine that the adjustment of the ink shaft is completed if the printing ink is in the gutter 16, and determine that the adjustment of the ink shaft is not completed if the printing ink is not in the gutter 16. The gutter sensor 16b is connected to the control unit 101 of the controller 100, and is configured to output a signal to the control unit 101.

The printing ink or solvent collected by the gutter 16 is sent back to the controller 100 through the ink supply pipe 44, the solvent supply pipe 54, and the like, and stored in the ink tank 106.

The printing ink or solvent collected by the gutter 16 is sent back to the controller 100 through the ink supply pipe 44, the solvent supply pipe 54, and the like, and stored in the ink tank 106.

(Cleaning Nozzle 17)

As exemplified in FIG. 3, the cleaning nozzle 17 is provided in the print head 1. The cleaning nozzle 19 functions as a so-called solvent spray unit. The cleaning nozzle 19 is a nozzle for cleaning the nozzle 12, the charging electrode 13, the deflection electrode 15, and the like in the print head 1 by spraying a solvent thereto, and can eject a solvent as a cleaning liquid. The solvent sprayed from the cleaning nozzle 17 is supplied from the solvent supply unit 105, for example, the solvent cartridge 51.

In the present embodiment, as exemplified by reference numeral L1 in FIG. 4B, the solvent jetted from the cleaning nozzle 17 is blown to at least the nozzle 12. Accordingly, the nozzle 12 can be cleaned. By cleaning the nozzle 12, the solvent can be smoothly ejected from the nozzle 12 at the time of head cleaning.

(Shutter 21)

The shutter 21 opens and closes the ejection port 10a. The shutter 21 is electrically connected to the control unit 101 and opens and closes in response to a control signal from the control unit 101. By closing the ejection port 10a by the shutter 21, for example, it is possible to suppress solvent leakage from the ejection port 10a at the time of head cleaning. Instead of closing the ejection port 10a by the shutter 21, the ejection port 10a may be closed by a cap or the like.

(Suction Device 22)

The suction device 22 sucks air from the internal space of the print head 1, particularly the inside of the flying space, and discharges the air to the external space of the print head 1. The suction device 22 is electrically connected to the control unit 101 and operates in response to a control signal from the control unit 101. By operating the suction device 22, air in the internal space of the print head 1 can be sucked and exhausted. The suction device 22 is an example of a "suction unit" and a "drying unit" in the present embodiment. Note that, since the continuous inkjet recording apparatus (CIJ) is installed in, for example, various factories, it is important to comply with various laws and regulations, for example, to ensure safety. By providing the suction device 22, there is also an advantage that the atomized solvent is less likely to leak from the ink ejection port, and thus it becomes easy to comply with laws and regulations.

(Filter 23)

The filter 23 filters the air sucked by the suction device 22. By filtering the air by the filter 23, the solvent (in particular, volatilized solvents) contained in the air and the odor inside the print head 1 can be removed.

(Posture Sensor 24)

The posture sensor 24 detects the orientation of the print head 1. The posture sensor 24 is, for example, an acceleration sensor or a gravity sensor. As illustrated in FIG. 3, the posture sensor 24 is attached to the print head 1. The posture sensor 24 is electrically connected to the control unit 101, and inputs a detection signal to the control unit 101.

(Assist Unit 18)

As exemplified in FIG. 3, the print head 1 further includes an assist unit 18. The assist unit 18 assists the cleaning when cleaning the components accommodated inside the print head 1 with the solvent supplied from the solvent supply unit 105. The "cleaning" as used herein is nothing other than the "head cleaning" described above. The components cleaned by the head cleaning include at least one of the gutter 16, the nozzle 12, and the deflection electrode 15. The assist unit 18 constitutes the assist module 70 in the present embodiment together with the above-described air generation unit 108.

Further, the assist in the present disclosure includes at least "air assist" using air and "mechanical assist" using a mechanical element. The assist unit 18 according to the present embodiment executes the former "air assist". When air assist is performed, the assist unit 18 blows air from an air jetting unit 181 to the solvent supplied into the print head 1.

The configuration related to "air assist" is exemplified in the present embodiment and a first modification described later. The "mechanical assist" is exemplified in a second modification and a third modification described later.

In either configuration, the configuration and structure of the assist unit 18 are closely related to the solvent supply from the solvent supply unit 105 to the print head 1. Therefore, before the assist unit 18 and eventually the assist module 70 are described in detail, a configuration related to a flow path of ink and a solvent in the inkjet recording apparatus I, specifically, a configuration related to the ink supply pipe 44 and the solvent supply pipe 54 will be described with reference to FIG. 5.

### Regarding Flow Path of Ink and Solvent

As described above, the ink supply pipe 44 supplies the ink from the ink cartridge 41 to the ink tank 106, and supplies the printing ink from the ink tank 106 to the print head 1. Meanwhile, the solvent supply pipe 54 supplies the solvent from the solvent cartridge 51 to each of the print head 1 and the ink tank 106.

First Path R1

The ink supply pipe 44 constitutes, for example, a path (first path R1) for feeding ink (ink before concentration adjustment) from the ink cartridge 41 to the ink tank 106.

As illustrated in FIG. 5, the first path R1 according to the present embodiment includes a first ink pipe 44a as an ink circulation pipe, a second ink pipe 44b, and a third ink pipe 44c. The first ink pipe 44a, the second ink pipe 44b, and the third ink pipe 44c are all arranged in the controller 100 in the present embodiment.

The first ink pipe 44a has one end connected to the ink hollow needle 43 and the other end (see a branch portion B1 in FIG. 5) branching into the second ink pipe 44b and the third ink pipe 44c. The first ink pipe 44a as an ink circulation pipe connects the ink hollow needle 43 and the ink tank 106 via the second ink pipe 44b and the third ink pipe 44c, and circulates the ink from the ink hollow needle 43 to the ink tank 106. In the present embodiment, the ink is introduced into the ink tank 106 through the third ink pipe 44c, but may be introduced through, for example, the second ink pipe 44b. In this case, the ink is introduced into the ink tank 106 without passing through a viscometer 46.

The classifications of the first ink pipe 44a, the second ink pipe 44b, and the third ink pipe 44c are merely for convenience. For example, the first ink pipe 44a and the second ink pipe 44b may be regarded as one ink circulation pipe. In this case, the ink circulation pipe constituted by the first ink pipe 44a and the second ink pipe 44b directly connects the ink hollow needle 43 and the ink tank 106.

The first pump P1 is arranged in the middle of the first ink pipe 44a. The first pump P1 is a suction pump for sucking so as to generate a flow from the ink hollow needle 43 toward the first ink pipe 44a.

A merging portion 45 is arranged in the first ink pipe 44a between the ink hollow needle 43 and the first pump P1. The merging portion 45 is configured to join the solvent or the ink in the first ink pipe 44a. In particular, the merging portion 45 exemplified in FIG. 5 is connected to a third solvent pipe 54c of the solvent supply pipe 54, and is configured to merge the solvent of the solvent and the ink with respect to the ink flowing through the first ink pipe 44a. The ink to be merged in the first ink pipe 44a may be a printing ink.

The eighth valve V8 is arranged in the first ink pipe 44a between the merging portion 45 and the first pump P1. The eighth valve V8 is an on-off valve that opens and closes the flow path of the first ink pipe 44a.

The second ink pipe 44b connects the other end (branch portion B1) of the first ink pipe 44a and the ink tank 106. The first valve V1 is arranged in the middle of the second ink pipe 44b. The first valve V1 is an on-off valve that opens and closes the flow path of the second ink pipe 44b.

The third ink pipe 44c connects the other end (branch portion B1) of the first ink pipe 44a and the ink tank 106. The 11th valve V11 is arranged in the middle of the third ink pipe 44c. The 11th valve V11 is an on-off valve that opens and closes the flow path of the third ink pipe 44c.

The viscometer 46 is arranged in the third ink pipe 44c between the 11th valve V11 and the ink tank 106. The viscometer 46 detects the flow rate of the ink or the printing ink flowing through the third ink pipe 44c, and measures the viscosity based on the flow rate. The viscometer 46 inputs a detection signal corresponding to the measurement result to the control unit 101. In the present embodiment, the viscometer 46 having the principle of detecting the ink flow rate is used, but the present invention is not limited thereto, and for example, the viscometer 46 that repeats the filling and discharge of the ink and measures the viscosity based on the time at the time of ink discharge may be used.

The ink from the ink cartridge 41 sequentially passes through the ink hollow needle 43, the ink reservoir 42, the first ink pipe 44a, the second ink pipe 44b, and the third ink pipe 44c based on the operation status of the first pump P1 and the opening/closing statuses of the first valve V1, the fifth valve V5, and the eighth valve V8, and is supplied to the ink tank 106.

Second Path R2

Meanwhile, the solvent supply pipe 54 constitutes a path (second path R2) for feeding the solvent from the solvent cartridge 51 to the ink tank 106 together with some elements of the ink supply pipe 44.

As illustrated in FIG. 5, the second path R2 according to the present embodiment includes the first solvent pipe 54a of the solvent supply pipe 54, a part of the first ink pipe 44a (a portion from the connection portion B2 to the branch portion B1 in FIG. 5), and all of the second ink pipe 44b and the third ink pipe 44c. In the present embodiment, the first solvent pipe 54a is arranged in the controller 100.

As described above, the names of the ink supply pipe 44 and the solvent supply pipe 54 are given focusing on a side surface of a part of each circulation pipe, and are merely for convenience. As in the first ink pipe 44a, the second ink pipe 44b, and the third ink pipe 44c, both ink circulation and solvent circulation may be achieved. Each circulation pipe may contribute to the configuration of one or more paths.

The first solvent pipe 54a has one end connected to the ink hollow needle 43 and the other end (connecting portion B2) connected to the first ink pipe 44a. A 13th valve V13 is arranged in the middle of the first solvent pipe 54a in the solvent supply pipe 54. The 13th valve V13 is an on-off valve that opens and closes the flow path of the first solvent pipe 54a.

The solvent from the solvent cartridge 51 sequentially passes through the solvent hollow needle 53, the solvent reservoir 52, and the first solvent pipe 54a according to the operating status of the first pump P1 and the opening/closing status of the 13th valve V13, and is supplied to a middle portion of the first ink pipe 44a (see the connecting portion B2 in FIG. 5). The solvent supplied to this portion sequentially passes through the first ink pipe 44a, the second ink pipe 44b, and the third ink pipe 44c according to the opening/closing statuses of the first valve V1 and the 11th valve V11, and is supplied to the ink tank 106.

The concentration of the ink supplied through the first path R1 is adjusted by the solvent supplied through the second path R2. Thus, the printing ink is stored in the ink tank 106.

Third Path R3

Returning to the description of the ink supply pipe 44, the ink supply pipe 44 also constitutes a path (third path R3) for circulating and stirring the stored object (printing ink) in the ink tank 106 in the controller 100.

As illustrated in FIG. 5, the third path R3 according to the present embodiment includes the fourth ink pipe 44d and the fifth ink pipe 44e of the ink supply pipe 44, a part of the first ink pipe 44a (a portion from the connection portion B2 to the branch portion B1 in FIG. 5), and all of the second ink pipe 44b and the third ink pipe 44c. The fourth ink pipe 44d and the fifth ink pipe 44e are both arranged in the controller 100 in the present embodiment.

The fourth ink pipe 44d has one end connected to the ink tank 106 and the other end (connecting portion B2) connected to the first ink pipe 44a. A ninth valve V9 is arranged in the middle of the fourth ink pipe 44d. The ninth valve V9 is an on-off valve that opens and closes the flow path of the fourth ink pipe 44d.

The fifth ink pipe 44e has one end connected to the ink tank 106 and the other end (connecting portion B2) connected to the first ink pipe 44a. The fifth valve V5 is arranged in the middle of the fifth ink pipe 44e. The fifth valve V5 is an on-off valve that opens and closes the flow path of the fifth ink pipe 44e.

The connection position between the fourth ink pipe 44d and the ink tank 106 (the position where the printing ink is sucked by the fourth ink pipe 44d) is higher than the connection position between the fifth ink pipe 44e and the ink tank 106 (the position where the printing ink is sucked by the fifth ink pipe 44e) in the height direction of the ink tank 106.

The printing ink in the ink tank 106 is sucked out by the fourth ink pipe 44d or the fifth ink pipe 44e based on the operation status of the first pump P1 and the opening/closing statuses of the first valve V1, the fifth valve V5, the ninth valve V9, and the 11 valve V11, and then sequentially passes through a part of the first ink pipe 44a (a portion from the connection portion B2 to the branch portion B1 in FIG. 5), the second ink pipe 44b, and the third ink pipe 44c, and is sent back to the ink tank 106. As a result, the printing ink circulates in the controller 100.

Furthermore, the printing ink can be stirred in the ink tank 106 by not only simply circulating in the controller 100 but also sucking out the printing ink from two places having different heights. Thus, the density of the printing ink can be made uniform (the dispersion state of the pigment can be maintained). This configuration is particularly effective when the pigment ink is used for the ink.

Fourth Path R4

The ink supply pipe 44 further forms a path (fourth path R4) for feeding the printing ink from the ink tank 106 to the nozzle 12 and feeding the printing ink back from the gutter 16 to the ink tank 106.

As illustrated in FIG. 5, the fourth path R4 according to the present embodiment is configured by the sixth ink pipe 44f and the seventh ink pipe 44g of the ink supply pipe 44. The sixth ink pipe 44f and the seventh ink pipe 44g both connect the controller 100 and the print head 1.

The sixth ink pipe 44f has one end connected to the ink tank 106 and the other end connected to the nozzle 12. The third pump P3 is arranged in the middle of the sixth ink pipe 44f. The third pump P3 is a suction pump for sucking so as to generate a flow from the ink tank 106 toward the sixth ink pipe 44f.

A 14th valve V14 is arranged in the sixth ink pipe 44f between the third pump P3 and the nozzle 12. The 14th valve V14 is an on-off valve that opens and closes the flow path of the sixth ink pipe 44f.

The seventh ink pipe 44g has one end connected to the gutter 16 and the other end connected to the ink tank 106. A fourth pump P4 is arranged in the middle of the seventh ink pipe 44g. The fourth pump P4 is a suction pump for sucking so as to generate a flow from the gutter 16 toward the seventh ink pipe 44g.

A tenth valve V10 is arranged in the seventh ink pipe 44g between the gutter 16 and the fourth pump P4. The tenth valve V10 is an on-off valve that opens and closes the flow path of the seventh ink pipe 44g.

The printing ink in the ink tank 106 is sucked out by the sixth ink pipe 44f according to the operating status of the third pump P3 and the opening/closing status of the 14th valve V14, and ejected from the nozzle 12. The printing ink ejected from the nozzle 12 lands on the surface of the print object W during printing, and is collected by the gutter 16 during non-printing. The latter printing ink is sucked out by the seventh ink pipe 44g according to the operation status of the fourth pump P4 and the opening/closing status of the tenth valve V10, and sent back to the ink tank 106. As a result, the printing ink circulates between the controller 100 and the print head 1.

Fifth Path R5

Meanwhile, the solvent supply pipe 54 constitutes a path (fifth path R5) for feeding a cleaning solvent from the solvent cartridge 51 to the nozzle 12 together with some elements of the ink supply pipe 44.

As illustrated in FIG. 5, the fifth path R5 according to the present embodiment is configured by a part of the first solvent pipe 54a (upstream end including the connection portion with the solvent hollow needle 53) and the second solvent pipe 54b in the solvent supply pipe 54, and a part of the sixth ink pipe 44f (downstream end including the connection portion with the nozzle 12). The second solvent pipe 54b connects the controller 100 and the print head 1.

The second solvent pipe 54b has one end connected to the first solvent pipe 54a between the solvent hollow needle 53 and the 13th valve V13, and the other end connected to the sixth ink pipe 44f between the 14th valve V14 and the nozzle 12. The second pump P2 is arranged in the middle of the second solvent pipe 54b in the solvent supply pipe 54. The second pump P2 is a suction pump for sucking so as to generate a flow from the solvent hollow needle 53 toward the solvent supply pipe 54 (particularly, the second solvent pipe 54b).

The 12th valve V12 is arranged in the second solvent pipe 54b between the second pump P2 and the nozzle 12. The 12th valve V12 is an on-off valve that opens and closes the flow path of the second solvent pipe 54b in the solvent supply pipe 54.

The solvent from the solvent cartridge 51 sequentially passes through the solvent hollow needle 53, the solvent reservoir 52, the first solvent pipe 54a, and the second solvent pipe 54b according to the operating status of the second pump P2 and the opening/closing status of the 12th valve V12, and is supplied to a middle portion of the sixth ink pipe 44f (a portion between the 14th valve V14 and the nozzle 12). The solvent supplied to this portion is ejected from the nozzle 12. This solvent cleans the print head 1.

The cleaning nozzle 17 is connected to the second solvent pipe 54b. As described above, the cleaning nozzle 17 can spray a solvent as a cleaning liquid. On the way from the cleaning nozzle 17 to the second solvent pipe 54b, a 15th valve V15 for controlling the supply of the solvent to the cleaning nozzle 17 is provided.

Sixth Path R6

The solvent supply pipe 54 further constitutes a path (sixth path R6) for feeding the solvent from the solvent cartridge 51 to the ink supply pipe 44 and the ink hollow needle 43 via the merging portion 45.

As illustrated in FIG. 5, the sixth route R6 according to the present embodiment includes a part of the first solvent pipe 54a, a part of the second solvent pipe 54b, and the third solvent pipe 54c in the solvent supply pipe 54. The "part of the first solvent pipe 54a" herein refers to a portion from the solvent hollow needle 53 to a connecting portion B3 of the first solvent pipe 54a and the second solvent pipe 54b. The "part of the second solvent pipe 54b" as used herein refers to a portion from the connecting portion B3 of the first solvent pipe 54a and the second solvent pipe 54b to a position between the second pump P2 and the 12th valve V12 (see a connecting portion B4 in FIG. 5). The sixth route R6 branches from the fifth route R5 on the downstream side of the second pump P2. The third solvent pipe 54c is arranged in the controller 100 in the present embodiment.

The third solvent pipe 54c has one end connected to the second solvent pipe 54b between the second pump P2 and the 12th valve V12, and the other end connected to the merging portion 45.

The third solvent pipe 54c constitutes a "solvent circulation pipe" in the present embodiment together with the part of the first solvent pipe 54a and the part of the second solvent pipe 54b. When the solvent reservoir 52 receives the solvent cartridge 51, the third solvent pipe 54c causes the solvent in the solvent cartridge 51 to flow to the merging portion 45 via the first solvent pipe 54a and the second solvent pipe 54b.

Here, the second pump P2 described above is arranged in the middle of the second solvent pipe 54b constituting the solvent circulation pipe. The second pump P2 can also be regarded as a solvent pump that operates to generate a flow from the second solvent pipe 54b toward the ink hollow needle 43 through the merging portion 45 and the first ink pipe 44a.

The 18th valve V18 is arranged in the second solvent pipe 54b between the merging portion 45 and the second pump P2. The 18th valve V18 is a second on-off valve that opens and closes the flow path of the second solvent pipe 54b.

### Path Related to Suction of Ink

The controller 100 also has a path associated with suction of ink. For example, the controller 100 has the suction path 47 connected to the nozzle 12. The suction path 47 is provided with a sixth valve V6. For example, at the time of non-printing, by operating the first pump P1 in a state where the sixth valve V6 is opened, the ink can be sucked via the suction path 47 and the sucked ink can be sent back to the controller 100.

### Details of Assist Module 70

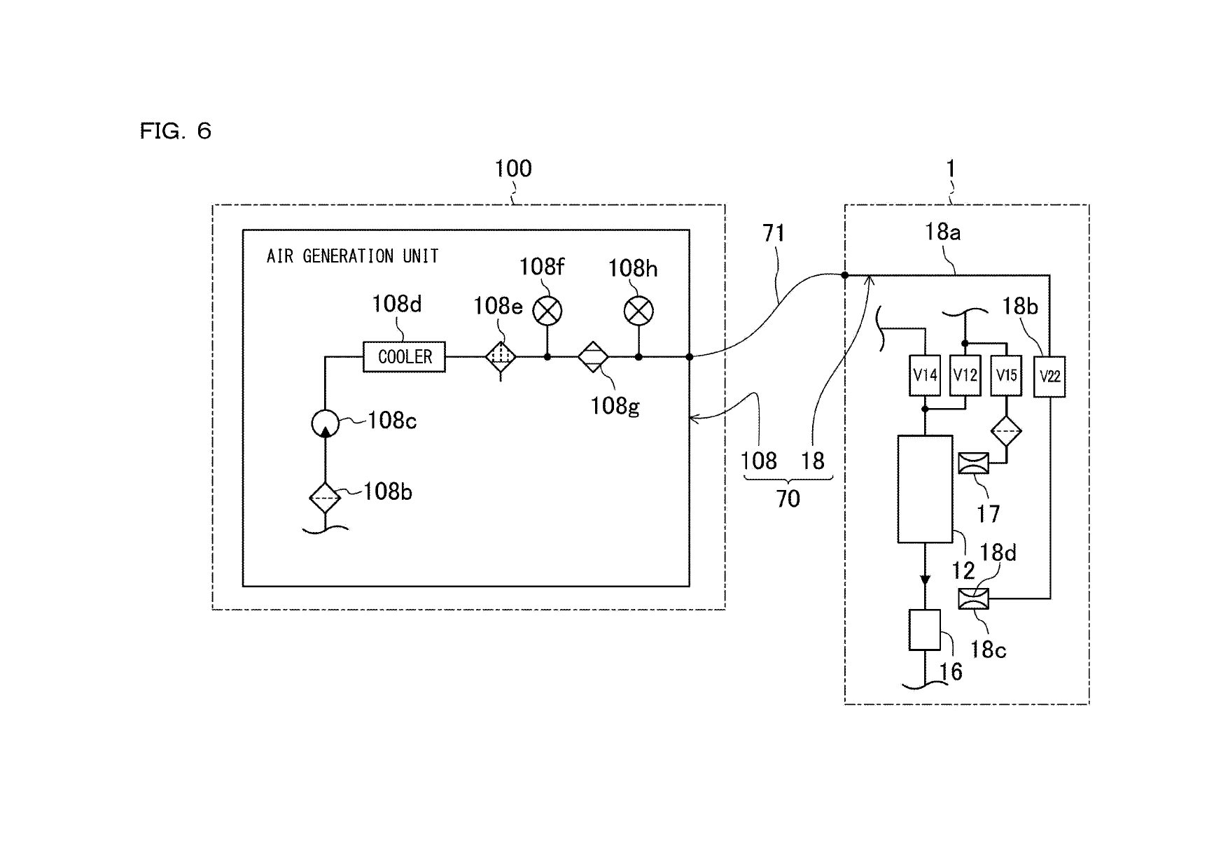

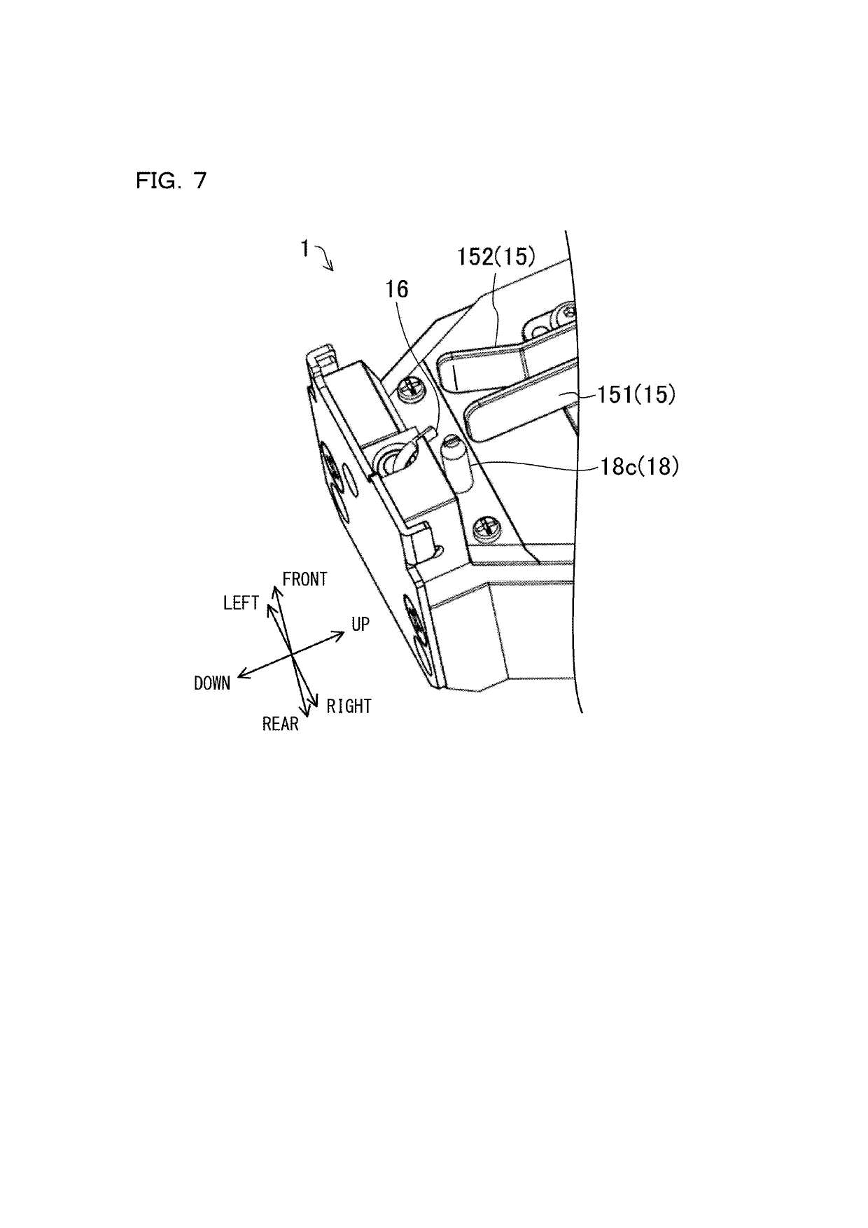

FIG. 6 is a diagram illustrating an overall configuration of the assist module 70. FIG. 7 is a perspective view illustrating an internal configuration of the print head 1. As described above, the assist module 70 according to the present embodiment includes the air generation unit 108 accommodated in the controller 100 and the assist unit 18 of the print head 1. The assist module 70 has a configuration suitable for the "air assist" described above.

Air Generation Unit 108

The air generation unit 108 generates air jetted from the air jetting unit 181 of the assist unit 18. The air generation unit 108 is necessary when the assist unit 18 performs "air assist". When the assist unit 18 performs "mechanical assist", the air generation unit 108 is not essential.

The air generated by the air generation unit 108 and jetted from the air jetting unit 181 may be, for example, high-pressure air. The high pressure air mentioned herein is specifically air of 100 kPa or more and 300 kPa, and more specifically air of 150 kPa or more and 250 kPa or less. As an example, the air jetting unit 181 according to the present embodiment jets high pressure air of slightly less than 200 kPa.

The air generation unit 108 may generate so-called dry air. As an example, the air generation unit 108 according to the present embodiment generates dry air, and the air jetting unit 181 jets the dry air at a high pressure.

Specifically, as illustrated in FIG. 5, the air generation unit 108 according to the present embodiment includes a first air duct 108a, an air filter 108b, an air pump 108c, a cooler 108d, a water separator 108e, a first pressure gauge 108f, an air dryer 108g, and a second pressure gauge 108h.

The first air duct 108a is a path through which air flows. In the first air duct 108a, the air filter 108b, the air pump 108c, the cooler 108d, the water separator 108e, the first pressure gauge 108f, the air dryer 108g, and the second pressure gauge 108h are arranged in this order from the upstream side.

The upstream end of the first air duct 108a is connected to an air tank arranged inside and outside the controller 100. The downstream end of the first air duct 108a is connected to the assist unit 18 via an umbilical cable 71. The umbilical cable 71 is bundled together with other ducts into the connection cable 107.

The air filter 108b is a filter that removes foreign substances from the air. The air passing through the air filter 108b subsequently reaches the air pump 108c.

The air pump 108c is, for example, a diaphragm type air pump built in the controller 100. The air pump 108c sucks the air that has passed through the air filter 108b and sends the air to the print head 1 via the cooler 108d, the water separator 108e, and the like. The air pump 108c is electrically connected to the control unit 101, and operates in response to a control signal from the control unit 101.

The cooler 108d cools the air whose temperature has risen by suction of the air pump 108c. The water separator 108e separates water generated by dew condensation due to suction by the air pump 108c from the air. The cooler 108d is electrically connected to the control unit 101, and operates in response to a control signal from the control unit 101.

The air dryer 108g is, for example, a hollow fiber membrane air dryer built in the controller 100. The air dryer 108g dries the air after passing through the water separator 108e to generate dry air. By incorporating the air dryer 108g in the controller 100, the print head 1 can be made compact.

The first pressure gauge 108f is arranged at a portion of the first air duct 108a between the water separator 108e and the air dryer 108g. The first pressure gauge 108f detects the pressure of the air at the portion. The first pressure gauge 108f is electrically connected to the control unit 101, and inputs a detection signal to the control unit 101. The control unit 101 determines whether the first air duct 108a upstream of the air dryer 108g is blocked or narrowed based on the detection signal from the first pressure gauge 108f.

The second pressure gauge 108h is arranged in a portion of the first air duct 108a downstream portion of the air dryer 108g. The second pressure gauge 108h detects the pressure of the air at the portion. The second pressure gauge 108h is electrically connected to the control unit 101, and inputs a detection signal to the control unit 101. Based on the detection signal of the second pressure gauge 108h, the control unit 101 determines whether the first air duct 108a, the umbilical cable 71, the air path (second air duct 18a) of the assist unit 18, the air jetting unit 18c, and the like downstream of the air dryer 108g are blocked or narrowed.

The second pressure gauge 108h is arranged on the way from the air dryer 108g to the assist unit 18, and exemplifies the "pressure sensor" in the present embodiment in that the second pressure gauge 108h can detect air blockage.

In addition, the first pressure gauge 108f and the second pressure gauge 108h can also be used to determine the pressure of the air jetted from the assist unit 18 when the pressure of the air is increased.

Assist Unit 18

The assist unit 18 jets the dry air generated by the air generation unit 108. The assist unit 18 according to the present embodiment has a configuration suitable for performing "air assist". The same applies to the first modification described later. When the "mechanical assist" is performed, the configuration and structure of the assist unit 18 are changed as in the second modification and the third modification described later.

Specifically, as illustrated in FIG. 5, the assist unit 18 according to the present embodiment includes the second air duct 18a, the electromagnetic valve 18b, and the air jetting unit 18c. The electromagnetic valve 18b according to the present embodiment corresponds to a “22nd valve V22" in FIG. 5.

The second air duct 18a is a path through which air flows. In the second air duct 18a, the electromagnetic valve 18b and the air jetting unit 18c are arranged in this order from the upstream side.

The upstream end of the second air duct 18a is connected to the downstream end of the umbilical cable 71. Dry air generated by the air generation unit 108 flows into the second air duct 18a via the umbilical cable 71.

The electromagnetic valve 18b is a control valve for controlling jetting of air generated by the air generation unit 108. The electromagnetic valve 18b is electrically connected to the control unit 101, and operates in response to a control signal from the control unit 101. The electromagnetic valve 18b operates to open and close the second air duct 18a, particularly the second air duct 18a upstream of the air jetting unit 18c.

The air jetting unit 18c jets air into the print head 1. For example, as illustrated in FIG. 6, the air jetting unit 18c is an air nozzle that jets dry air generated by the air generation unit 108. The air jetting unit 18c as an air nozzle has an openable orifice 18d. The orifice 18d is electrically connected to the control unit 101, and is opened and closed in response to a control signal from the control unit 101.

Specifically, as illustrated in FIGS. 4A and 7, the air jetting unit 18c according to the present embodiment is located between the gutter 16 and the first electrode plate 151 in the up-down direction. The air jetting unit 18c is arranged at substantially the same position as the leading end (ink or solvent receiving port) of the gutter 16 and the first electrode plate 151 in the left-right direction.

Specifically, as exemplified in FIG. 4A, the air jetting axis Aa in the air jetting unit 18c extends toward the deflection electrode 15, more specifically, toward the second electrode plate 152. The "air jetting axis Aa" as used herein refers to the central axis of the air jetted from the air jetting unit 18c. That is, the air jetting unit 18c according to the present embodiment jets air toward the deflection electrode 15, particularly toward the second electrode plate 152.

More specifically, the air jetting axis Aa of the air jetting unit 18c intersects with the central axis Ax of the solvent shaft as exemplified in FIG. 4A. That is, the air jetting unit 18c according to the present embodiment is arranged such that the solvent shaft ejected from the nozzle 12 is interposed between the air jetting unit 18c and the deflection electrode 15, particularly, the second electrode plate 152.

The control unit 101 operates the air pump 108c in a state where the electromagnetic valve 18b or the orifice 18d is closed. Accordingly, the pressure of the dry air can be increased. When the electromagnetic valve 18b or the orifice 18d is opened in a state where the pressure of the dry air is increased, the dry air is jetted from the air jetting unit 18c.

As exemplified by reference numeral M1 in FIG. 4B, the assist unit 18 applies the air (dry air) jetted from the air jetting unit 18c to the solvent supplied from the solvent supply unit 105. By applying the dry air to the solvent, cleaning by the solvent is assisted.

Specifically, in the example illustrated in FIGS. 4A and 4B, as described above, the solvent shaft ejected from the nozzle 12 is interposed between the air jetting unit 18c and the second electrode plate 152. Therefore, as indicated by reference numeral M1 in FIG. 4B, the assist unit 18 according to the present embodiment can apply the dry air to the shaft-like solvent (solvent shaft) ejected from the nozzle 12 or the drop-like solvent ejected from the nozzle 12.

More specifically, the assist unit 18 atomizes the solvent as indicated by reference numeral M1 in FIG. 4B by applying the air (dry air) jetted from the air jetting unit 18c to the solvent supplied from the solvent supply unit 105. The atomization of the solvent is realized, for example, by increasing the pressure of the air. The high-pressure air hits the solvent shaft and then collides with the second electrode plate 152. By causing air to collide with the second electrode plate 152, dirt adhering to the second electrode plate 152 is easily removed. Further, by atomizing the solvent, the cleaning area of the component by the solvent is enlarged as compared with the case where the solvent is not atomized.

The control unit 101 includes the cleaning control unit 101a as a functional element for controlling head cleaning by the solvent supply unit 105 and the assist unit 18. The cleaning control unit 101a is an example of a "cleaning management unit" in the present embodiment.

The cleaning control unit 101a as a cleaning management unit manages the amount of solvent used at the time of head cleaning so that an amount of solvent corresponding to the air jetted from the air jetting unit 18c is supplied and leakage of the solvent from the ejection port 10a is suppressed. This process is common to both "air assist" and "mechanical assist" described later. Details of a method of managing the usage amount will be described later.

The cleaning control unit 101a can change the head cleaning sequence based on the detection signal of the posture sensor 24. The sequence to be changed includes, for example, the amount of solvent supplied from the solvent supply unit 105. This suppresses solvent leakage from the print head 1, particularly its housing 10.

Further, the cleaning control unit 101a operates the shutter 21 to close the ejection port 10a upon the assist by the assist unit 18. This suppresses solvent leakage from the print head 1, particularly its housing 10.

Further, the cleaning control unit 101a operates the suction device 22 to suck and exhaust air from the inside of the print head 1 when the ejection port 10a is closed by the shutter 21 at the time of assist. As a result, the inside of the print head 1 is dried, and the solvent adhering to the inside of the print head 1 volatilizes. As a result, solvent leakage from the print head 1, particularly the housing 10 thereof, is suppressed. Although the ejection port 10a is closed by the shutter 21 here, the ejection port 10a may not necessarily be closed by the shutter 21 as long as the suction device 22 is operated, for example. In this case, it is possible to suppress the solvent from leaking from the housing 10 even if the configuration without a shutter is adopted.

Hereinafter, specific processing performed by the control unit 101 will be described in detail.

### Specific Example of Process

### Necessity Determination of Head Cleaning

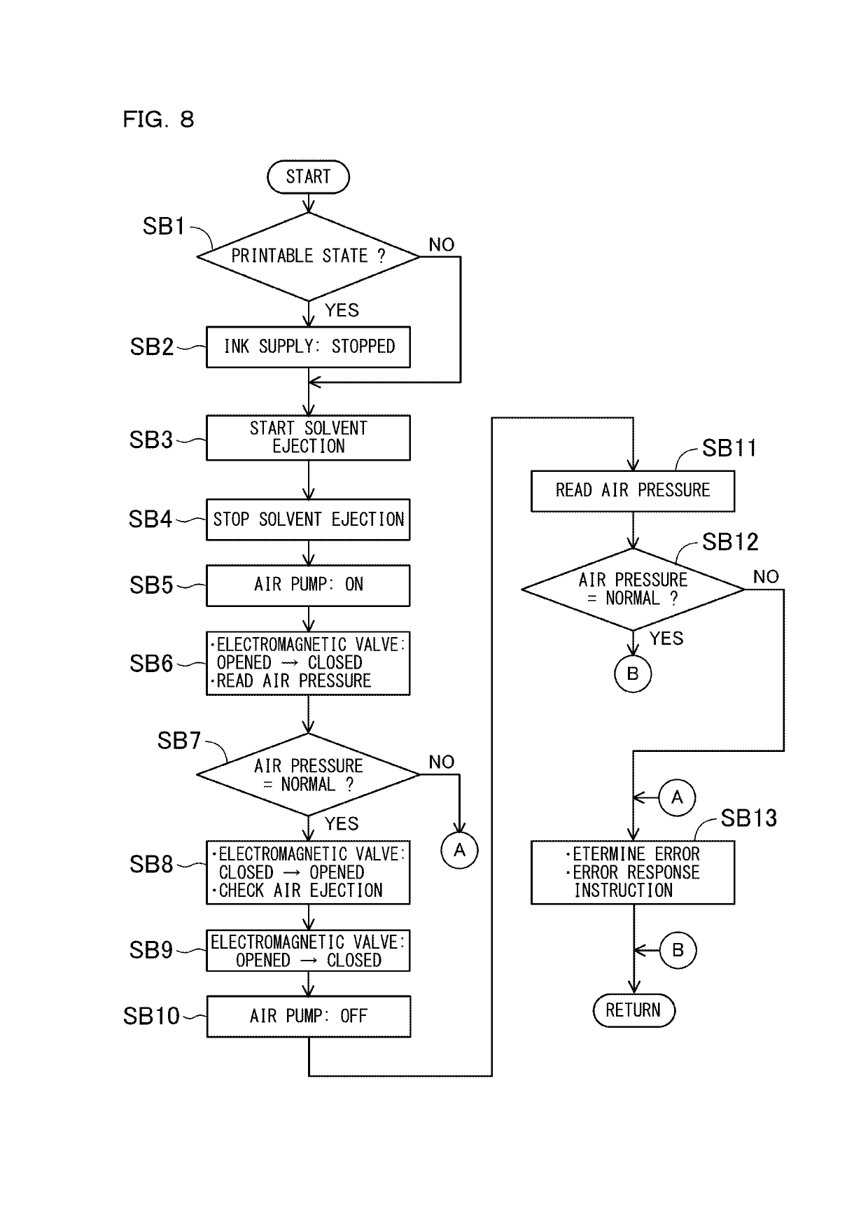

FIG. 8 is a flowchart illustrating a process related to necessity determination of head cleaning. The process illustrated in FIG. 8 is performed by the control unit 101, for example, when the inkjet recording apparatus I recovers from an error state (at the time of error recovery) and when an execution instruction of head cleaning is input via the operation display unit 103. In the process of FIG. 8, the orifice 18d may be opened and closed instead of opening and closing the electromagnetic valve 18b or in addition to opening and closing the electromagnetic valve 18b.

First, in step SB1, the cleaning control unit 101a determines whether the inkjet recording apparatus I is in a printable state. The printable state refers to a state in which ink circulates inside the inkjet recording apparatus I. The determination in step SB1 can be made based on, for example, a detection signal of the gutter sensor 16b.

When the determination in step SB1 is YES, the cleaning control unit 101a advances the control process to step SB2. On the other hand, when the determination in step SB1 is NO, the cleaning control unit 101a advances the control process to step SB3.

In step SB2, the cleaning control unit 101a stops ink supply from the controller 100 to the print head 1 to stop ink circulation. As a result, the ejection of ink from the nozzles 12 is also stopped. This process is executed, for example, by closing the 14th valve V14 in FIG. 5.

In step SB3, the cleaning control unit 101a starts ejecting the solvent from the nozzle 12 by supplying the solvent from the controller 100 to the print head 1. By performing step SB3, the solvent ejected from the nozzle 12 is recovered by the gutter 16 at this stage. The process of step SB3 is executed, for example, by opening the 12th valve V12 in FIGS. 5 and 6.

Immediately thereafter, in step SB4, the cleaning control unit 101a stops ejecting the solvent from the nozzle 12. The process of step SB4 is executed, for example, by closing the 12th valve V12 in FIGS. 5 and 6.

By continuously performing steps SB3 and SB4, the solvent is filled up to the solvent supply pipe 54 on the upstream side of the 12th valve V12, and the solvent is discharged from the solvent supply pipe 54 on the downstream side of the 12th valve V12. Thus, the amount of solvent used at the time of head cleaning is controlled. That is, a fixed amount of solvent can be used as much as possible in head cleaning. This makes it possible to suppress the solvent from leaking from the ejection port 10a at the time of head cleaning.

The time interval from the completion of step SB3 to the start of step SB4 may be set within a range of, for example, 50msec to 150msec.

In subsequent step SB5, the cleaning control unit 101a operates the air pump 108c (air pump: ON). In subsequent step SB6, the cleaning control unit 101a closes the electromagnetic valve 18b (electromagnetic valve: open → closed) and reads the pressure of the air generated by the air generation unit 108. As the pressure of the air read here, for example, the pressure detected by the first pressure gauge 108f can be used.

In subsequent step SB7, the cleaning control unit 101a determines whether the above-described air pressure is normal based on the read content in step SB6. This determination can be made based on whether or not the detection pressure of the air exceeds a predetermined reference value.

When the determination in step SB7 is YES, the cleaning control unit 101a advances the control process to step SB8. On the other hand, when the determination in step SB7 is NO, the cleaning control unit 101a advances the control process to step SB13. For example, clogging of the air filter 108b can be considered as a cause of NO in the determination in step SB7. Therefore, in step SB13, the cleaning control unit 101a makes an "error determination" assuming that the head cleaning cannot be normally executed, and displays a cleaning instruction or the like of the air filter 108b on the operation display unit 103 in order to remove an error factor.

In step SB8, the cleaning control unit 101a opens the electromagnetic valve 18b (electromagnetic valve: closed → opened) and determines whether air is being ejected from the air jetting unit 18c. The air ejection can be determined based on, for example, a change in the detected pressure based on the detection signal of the first pressure gauge 108f.

In subsequent step SB9, the cleaning control unit 101a closes the electromagnetic valve 18b (electromagnetic valve: open → closed). In subsequent step SB10, the cleaning control unit 101a stops the air pump 108c (air pump: OFF). The air pump 108c may be stopped, for example, on condition that the pressure detected by the second pressure gauge 108h reaches a predetermined prescribed pressure.

In subsequent step SB11, the pressure of the air generated by the air generation unit 108 is read. The pressure of the air read here may be, for example, the pressure detected by the second pressure gauge 108h.

In subsequent step SB12, the cleaning control unit 101a determines whether the above-described air pressure is normal based on the read content in step SB11. This determination can be made based on the decrease rate of the detection pressure of the air, that is, the air release speed from the air jetting unit 18c as the air nozzle.

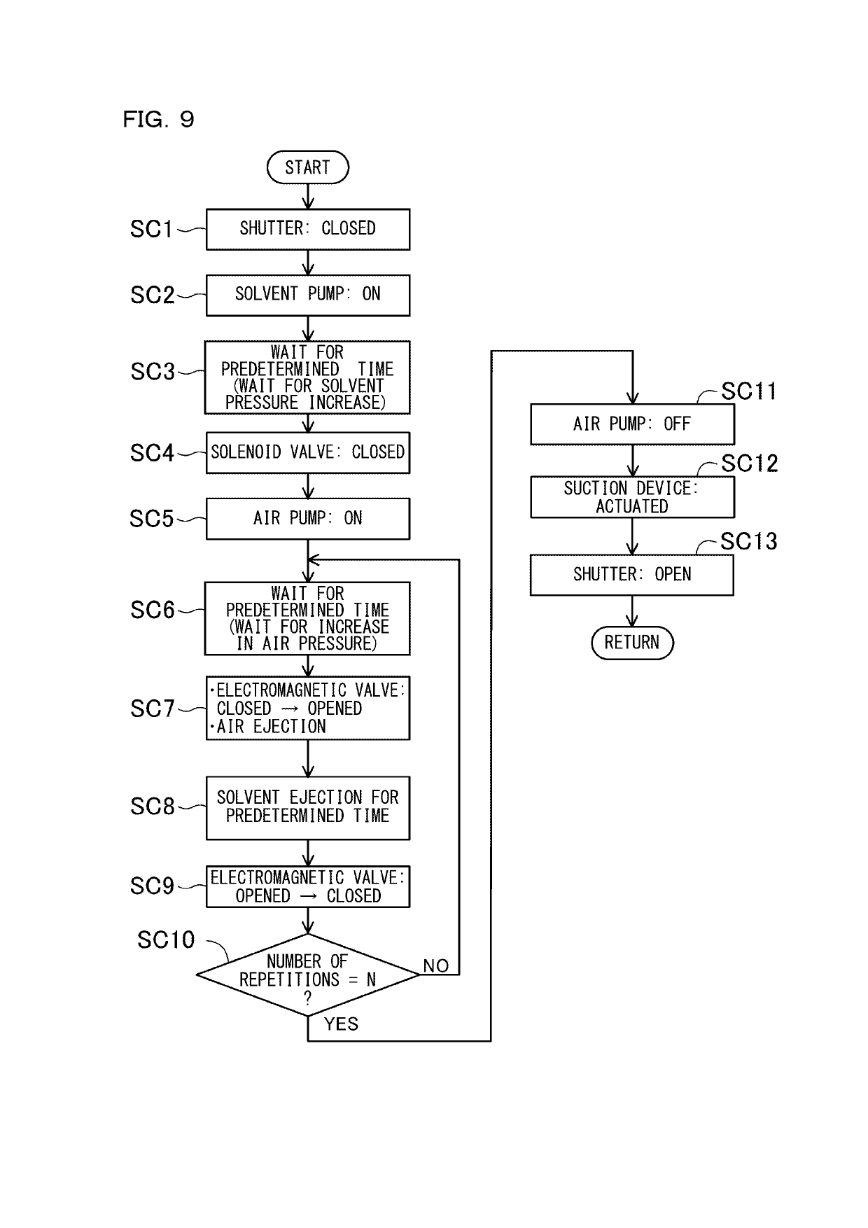

If the determination in step SB12 is YES, the cleaning control unit 101a ends the control process exemplified in FIG. 8 and starts the control process exemplified in FIG. 9. On the other hand, when the determination in step SB12 is NO, the cleaning control unit 101a advances the control process to step SB13. As a factor by which the determination at step SB12 is NO, for example, narrowing or blockage of the air path downstream of the air dryer 108g can be considered. Therefore, in step SB13, the cleaning control unit 101a performs "error determination" assuming that the head cleaning cannot be normally executed, and displays a cleaning instruction or the like of the air path on the operation display unit 103 in order to remove an error factor.

### Specific Process of Head Cleaning

FIG. 9 is a flowchart illustrating a specific process of head cleaning. The process illustrated in FIG. 9 is continuously performed, for example, when the determination in step SB12 is YES in FIG. 8.

In the process of FIG. 9, the orifice 18d may be opened and closed instead of opening and closing the electromagnetic valve 18b or in addition to opening and closing the electromagnetic valve 18b. Instead of automatically opening and closing the shutter 21 as in steps SC1 and SC13 described later, the ejection port 10a may be manually opened and closed by the shutter 21 or a cap similar to the shutter 21.

First, in step SC1, the cleaning control unit 101a operates the shutter 21 to close the ejection port 10a before the assist by the assist unit 18 is performed.

In subsequent step SC2, the cleaning control unit 101a operates the solvent pump (second pump P2). As a result, the solvent reaches the solvent supply pipe 54 immediately upstream of the 12th valve V12.

In subsequent step SC3, the cleaning control unit 101a waits for a predetermined time in order to wait for an increase in the pressure of the solvent.

In subsequent step SC4, the cleaning control unit 101a closes the electromagnetic valve 18b. When the electromagnetic valve 18b is already closed at the time of transition to step SC4, the cleaning control unit 101a maintains the electromagnetic valve 18b in the closed state.

In subsequent step SC5, the cleaning control unit 101a operates the air pump 108c. As a result, the dry air reaches the second air duct 18a immediately upstream of the electromagnetic valve 18b.

In subsequent step SC6, the cleaning control unit 101a waits for a predetermined time in order to wait for an increase in the pressure of the dry air.

In subsequent step SC7, the cleaning control unit 101a opens the electromagnetic valve 18b. As a result, the dry air that has reached the second air duct 18a immediately upstream of the electromagnetic valve 18b is jetted from the air jetting unit 18c. At this time, the dry air is jetted toward the second electrode plate 152 along the jetting axis Aa in FIG. 4A.

In subsequent step SC8, the cleaning control unit 101a opens the 12th valve V12 for a predetermined time. As a result, the solvent is supplied from the nozzle 12 over the predetermined period.

The solvent supplied from the nozzle 12 into the print head 1 flows along the central axis Ax. The central axis Ax intersects with the jetting axis Aa as described above. Therefore, the dry air jetted from the air jetting unit 18c along the jetting axis Aa collides with the solvent flowing along the central axis Ax. At that time, by increasing the pressure of the dry air, the solvent collided with the dry air is more reliably atomized.

The atomized solvent hits the second electrode plate 152. The second electrode plate 152 is cleaned with the solvent. Even if the solvent that has hit the second electrode plate 152 is converted into a droplet, the solvent converted into the droplet is guided in a direction away from the ejection port 10a by the folding curved surface 152c. As a result, leakage of the solvent from the ejection port 10a is suppressed.

The valve opening time of the 12th valve V12 in step SC8 is changed, for example, based on the detection signal of the posture sensor 24. The change of the valve opening time based on the detection signal of the posture sensor 24 is an example of "change of cleaning sequence" in the present embodiment.

For example, when the print head 1 directs its ejection port 10a downward along the vertical direction, the dry air and the solvent can more reliably collide with each other. In this case, since the solvent is more reliably atomized, the valve opening time of the 12th valve V12 becomes relatively long in order to atomize a larger amount of the solvent. On the other hand, when the ejection port 10a of the print head 1 is directed along the horizontal direction or directed upward along the vertical direction, it is inconvenient to cause the dry air and the solvent to collide with each other. In this case, since it is also inconvenient for atomization of the solvent, the valve opening time of the 12th valve V12 becomes relatively short in order to atomize a smaller amount of solvent.

Before step SC8 to step SC9, the solvent supply is stopped by closing the 12th valve V12. Stop of solvent supply means stop of a cleaning treatment (head cleaning). Therefore, at the timing immediately before step SC9, only the jetting of the dry air from the air jetting unit 18c, more generally, the assist by the assist unit 18 is executed. The second electrode plate 152 can be dried by jetting dry air without interposing a solvent.

As described above, the cleaning control unit 101a according to the present embodiment executes the drying treatment for drying the inside of the print head 1 by causing the assist unit 18 to execute the assist when the solvent is not supplied from the solvent supply unit 105.

In step SC9, the cleaning control unit 101a closes the electromagnetic valve 18b. Accordingly, the air assist by the assist unit 18 is also temporarily completed.

In subsequent step SC10, the cleaning control unit 101a determines whether the number of executions of the cleaning treatment of cleaning the component (for example, the second electrode plate 152) accommodated inside the print head 1 with the solvent supplied from the solvent supply unit 105 and the drying treatment by air assist has reached a predetermined number of repetitions. When the determination is NO, the cleaning control unit 101a returns the control process to step SC6. When the determination is YES, the cleaning control unit 101a advances the control process to step SC11. The number of repetitions may be stored in advance in the control unit 101.

That is, the cleaning control unit 101a according to the present embodiment is configured to execute the assist by the assist unit 18 while turning on and off the solvent supply from the solvent supply unit 105 to alternately and repeatedly execute the cleaning treatment and the drying treatment until the number of executions of the cleaning treatment and the drying treatment reaches the number of repetitions.

In subsequent step SC11, the cleaning control unit 101a stops the air pump 108c (air pump: OFF). In subsequent step SC12, the cleaning control unit 101a operates the suction device 22. The operation of the suction device 22 ventilates the inside of the print head 1 and dries the inside. This drying evaporates the solvent. The operation of the suction device 22 in a state where the ejection port 10a is closed by the shutter 21 contributes to drying of the inside of the print head 1.

That is, the cleaning control unit 101a according to the present embodiment is configured to dry the inside of the print head 1 by the suction device 22 when the ejection port 10a is closed by the shutter 21.

In subsequent step SC12, the cleaning control unit 101a opens the shutter 21. As a result, the control process exemplified in FIG. 9 is completed.

### Reduction of Solvent Consumption Amount in Present Embodiment

In the case of a general continuous inkjet recording apparatus, ink particles continue to fly in the internal space of the print head. Therefore, dirt is likely to accumulate inside the print head. The interior of the print head needs to be periodically cleaned.

Conventionally, cleaning (head cleaning) of a print head has been performed by spraying a solvent into the print head by a user himself or herself, or by automatically ejecting the solvent from a cleaning nozzle provided in the print head after the print head is placed on a cleaning placement portion as known.

However, when a large amount of dirt accumulates in the print head due to long-term use, a large amount of solvent is consumed regardless of whether the head is cleaned by the user himself/herself or the head is cleaned by a cleaning nozzle. In addition, when a large amount of dirt accumulates, it is not easy to remove the dirt even if head cleaning is performed.

Therefore, it is conceivable to perform head cleaning with high frequency before a large amount of dirt accumulates, that is, before the dirt becomes difficult to remove. However, when the head cleaning is performed with high frequency, the number of times of use of the solvent increases, and thus a large amount of solvent is consumed as a result.

The consumption of a large amount of solvent increases the frequency of solvent replenishment, which is disadvantageous in improving the convenience of the inkjet recording apparatus.

The problem to be solved by the embodiment is to reduce the solvent consumption amount in the head cleaning and to enhance the convenience of the inkjet recording apparatus. In view of such a problem, according to the present embodiment, as exemplified in FIGS. 4B and 9, the assist unit 18 assists the head cleaning. The amount of solvent consumed in head cleaning can be reduced by the assist by the assist unit 18. Accordingly, the convenience of the inkjet recording apparatus I can be enhanced.

Further, as exemplified in FIG. 4B, the solvent supplied from the solvent supply unit 105 can be blown to the components in the print head 1 by air. By blowing the solvent onto the components, dirt adhering to the components is easily removed. This makes it possible to exhibit a sufficient cleaning effect while reducing the solvent consumption amount.

In addition, as exemplified in FIG. 4B, the solvent supplied from the solvent supply unit 105 can be atomized by air and then blown onto the components in the print head. The atomization of the solvent contributes to expansion of a cleaning area of the component. This makes it possible to exhibit a sufficient cleaning effect while reducing the solvent consumption amount.

As exemplified in FIG. 8, the cleaning control unit 101a as the cleaning management unit manages the amount of solvent used. By this, together with the assist of the cleaning by the assist unit 18, the solvent consumption amount can be further reduced.

Further, as exemplified in FIG. 4B, the solvent supplied from the nozzle 12 can be blown to the components in the print head 1 by air. In the case of a general continuous type inkjet recording apparatus, the ejection amount of the solvent from the nozzle 12 can be precisely controlled. Precise control of the ejection amount of the solvent contributes to reduction of solvent consumption amount.

Furthermore, in general, the dirt caused by the ink gradually accumulates on the deflection electrode 15 as the inkjet recording apparatus I is repeatedly used. On the other hand, according to the present embodiment, as described with reference to FIG. 4B, the solvent can be blown onto the deflection electrode 15, and the dirt adhering to the deflection electrode 15 is easily removed. This is advantageous in exerting a sufficient cleaning effect while reducing the solvent consumption amount.

In general, a high voltage is applied to the second electrode plate 152 that is not grounded. In this case, the charged ink is attracted to the second electrode plate 152 more than the grounded first electrode plate 151. The second electrode plate 152 is more likely to accumulate dirt than the first electrode plate 151.

On the other hand, the air jetting unit 18c according to the above embodiment blows a solvent toward the second electrode plate 152 at the time of assist by the assist unit 18. This makes it possible to more reliably clean the second electrode plate 152 assumed to be likely to accumulate dirt.

In addition, as exemplified in FIG. 4A, by providing the folding curved surface 152c on the second electrode plate 152, the flow direction of the air jetted toward the second electrode plate 152 can be guided in a direction away from the shaft-like solvent. As a result, the flow direction of the solvent carried by the flow of air can also be guided in a direction away from the shaft-like solvent. As a result, leakage of the solvent from the ink ejection port 10a is suppressed, and eventually, the convenience of the inkjet recording apparatus I is enhanced.

In addition, as exemplified in FIG. 6, by arranging the control valve (the electromagnetic valve 18b) in the print head 1 and arranging the air generation unit 108 in the controller 100, the print head 1 can be made compact by the amount by which the air generation unit 108 is removed from the print head 1. Accordingly, the convenience of the inkjet recording apparatus I can be enhanced.

In addition, in order to promote blowing of the solvent by the air or realize expansion of the cleaning area by atomization of the air, it is conceivable to generate higher pressure air. However, when the air is increased in pressure by the air generation unit 108 in the controller 100, dew condensation may occur inside the controller 100.

On the other hand, according to the above embodiment, as exemplified in FIG. 6, the air generation unit 108 generates dry air by the air dryer 108g. By configuring to generate the dry air, even if the air generation unit 108 is arranged in the controller 100, the occurrence of dew condensation can be suppressed.

By laying out the second pressure gauge 108h as illustrated in FIG. 6, it is possible to detect blockage of the dry air after passing through the air dryer 108g. Accordingly, the convenience of the inkjet recording apparatus I can be enhanced.

Further, as exemplified in FIG. 4A, by providing the suction device 22 in the inkjet recording apparatus I, the internal space of the print head 1 can be dried and the volatilized solvent can be discharged. Accordingly, the convenience of the inkjet recording apparatus I can be enhanced.

Furthermore, as described with respect to step SC8 of FIG. 9, the convenience of the inkjet recording apparatus I can be enhanced by changing the cleaning sequence according to the posture of the print head 1.

Furthermore, as exemplified in FIG. 4A, by providing the shutter 21 that opens and closes the ejection port 10a, it is possible to suppress the solvent from leaking from the ejection port 10a, and eventually enhance the convenience of the inkjet recording apparatus I.

Furthermore, as exemplified in step SC1 of FIG. 9, by closing the ejection port 10a before the start of the assist, the solvent leakage from the ejection port 10a can be more reliably suppressed, and eventually, the convenience of the inkjet recording apparatus I can be enhanced.

Furthermore, as exemplified in step SC12 of FIG. 9, by drying the inside of the print head 1 in a state where the ejection port 10a is closed, leakage of the solvent from the ejection port 10a can be more reliably suppressed, and eventually, the convenience of the inkjet recording apparatus I can be enhanced.

Further, as described with reference to FIG. 9, the components inside the print head 1 can be dried by blowing air to the components (for example, the second electrode plate 152) when the solvent is not supplied. Accordingly, the convenience of the inkjet recording apparatus I can be enhanced.

Further, as described with reference to FIG. 9, by alternately and repeatedly executing the cleaning treatment and the drying treatment, head cleaning can be performed while drying the solvent each time. Thus, the solvent leakage can be more reliably suppressed, and the convenience of the inkjet recording apparatus I can be enhanced.

### First Modification of Inkjet Recording System S

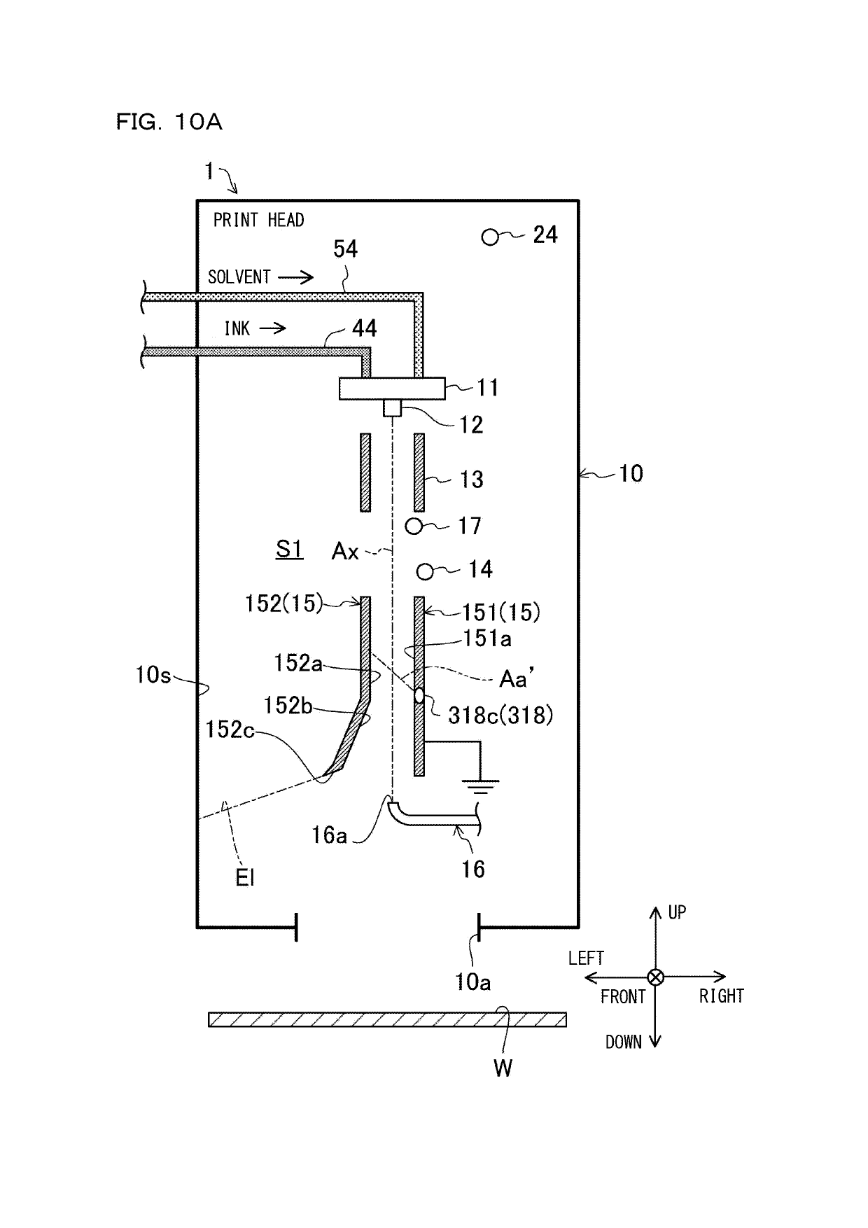

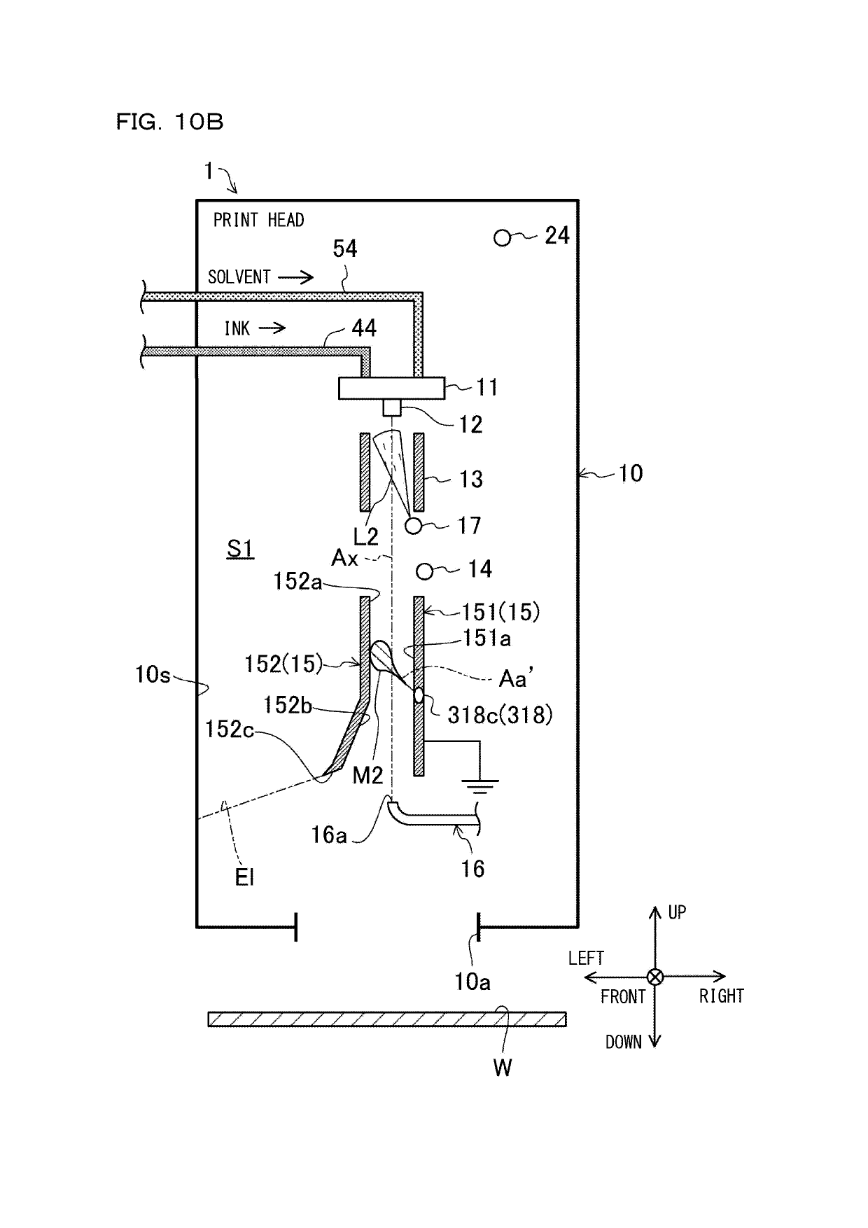

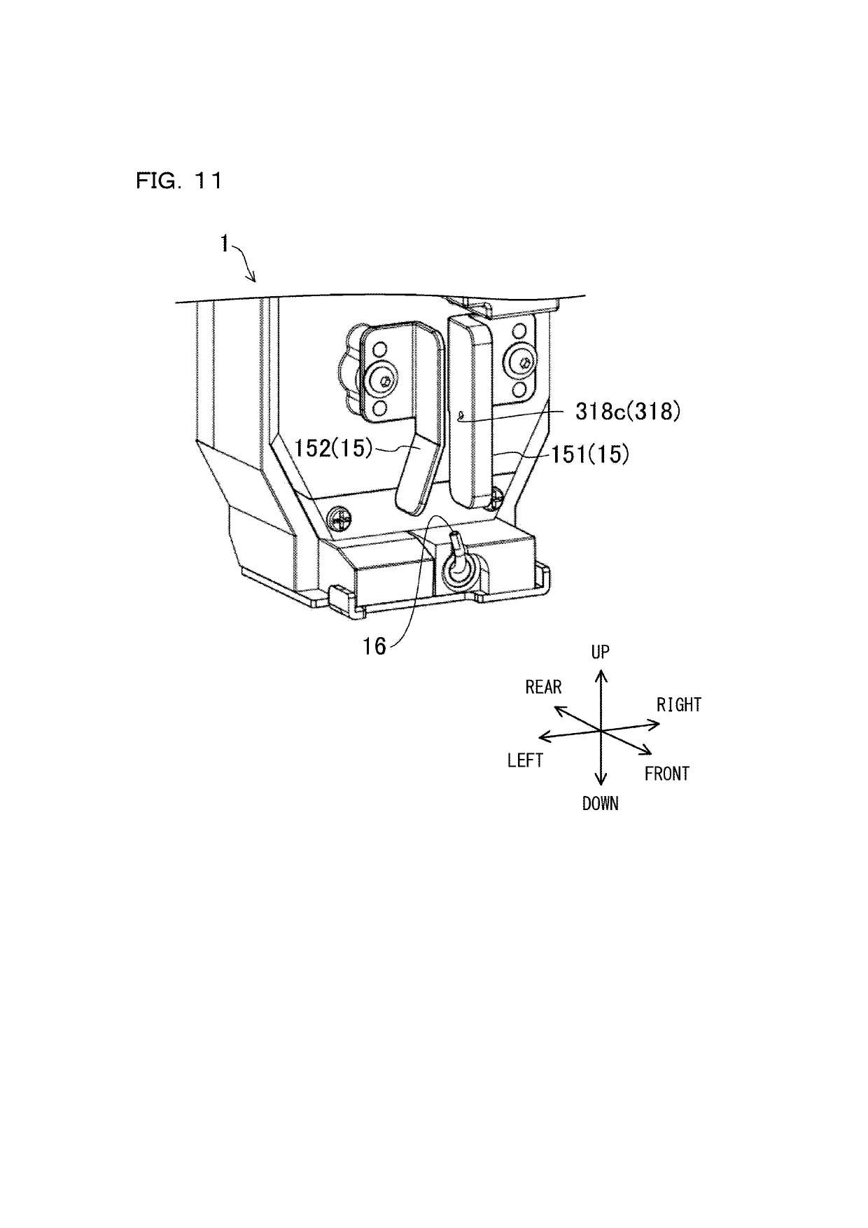

FIG. 10A is a diagram corresponding to FIG. 4A illustrating a first modification of the inkjet recording system S. FIG. 10B is a diagram corresponding to FIG. 4B illustrating the first modification of the inkjet recording system S. FIG. 11 is a diagram illustrating an internal structure of a print head 1 according to the first modification. In FIGS. 10A, 10B, and 11, elements having the same configurations and structures as those of the embodiment are denoted by the same reference numerals as those of the embodiment.

The print head 1 according to the first modification includes a cleaning nozzle 17 arranged similarly to the above embodiment. As exemplified by reference numeral L2 in FIG. 10B, the solvent jetted from the cleaning nozzle 17 is blown to at least the nozzle 12. Accordingly, the nozzle 12 can be cleaned. By cleaning the nozzle 12, the solvent can be smoothly ejected from the nozzle 12 at the time of head cleaning.

In addition, the print head 1 according to the first modification includes an assist unit 318 that assists the cleaning when the cleaning of the components accommodated inside the print head 1 is performed by the solvent supplied from the solvent supply unit 105, similarly to the embodiment.

The assist unit 318 jets the dry air generated by the air generation unit 108 similar to that of the embodiment into the print head 1. That is, the assist unit 318 according to the first modification executes "air assist" similarly to the above-described embodiment.

Specifically, the assist unit 318 according to the first modification includes a second air duct 18a and an electromagnetic valve 18b configured similarly to the above embodiment, and an air jetting unit 318c having a configuration specific to the first modification.

The air jetting unit 318c jets air into the print head 1. For example, as illustrated in FIG. 6, the air jetting unit 318c is an air nozzle that jets dry air generated by the air generation unit 108, and is configured similarly to the above-described embodiment in that the air jetting unit 318c is opened and closed in response to a control signal from the control unit 101.

On the other hand, as illustrated in FIGS. 10A, 10B, and 11, the air jetting unit 318c according to the first modification is arranged on the first electrode plate 151 so as to jet air toward the second electrode plate 152. The air jetting unit 318c is embedded in the first electrode plate 151 and open to the first facing surface 151a.

Specifically, the air jetting axis Aa’ in the air jetting unit 318c extends toward the deflection electrode 15, more specifically, the second facing surface 152a of the second electrode plate 152, as exemplified in FIG. 10B. That is, the air jetting unit 318c according to the first modification jets air toward the deflection electrode 15, particularly toward the second facing surface 152a of the second electrode plate 152.

More specifically, as exemplified in FIG. 10A, the air jetting axis Aa' of the air jetting unit 318c extends obliquely upward and intersects with the central axis Ax of the solvent shaft. That is, the air jetting unit 318c according to the first modification is arranged so that the solvent shaft ejected from the nozzle 12 is interposed between the air jetting unit 318c and the deflection electrode 15, particularly, the second electrode plate 152, similarly to the above-described embodiment.

The control unit 101 operates the air pump 108c in a state where the electromagnetic valve 18b or the orifice 18d is closed. Accordingly, the pressure of the dry air can be increased. When the electromagnetic valve 18b or the orifice 18d is opened in a state where the pressure of the dry air is increased, the dry air is jetted from the air jetting unit 318c.

As exemplified by reference numeral M2 in FIG. 10B, the assist unit 318 applies the air (dry air) jetted from the air jetting unit 318c to the solvent supplied from the solvent supply unit 105. By applying the dry air to the solvent, cleaning by the solvent is assisted.

Specifically, in the example illustrated in FIGS. 10A and 10B, as described above, the solvent shaft ejected from the nozzle 12 is interposed between the air jetting unit 318c and the second electrode plate 152. Therefore, as indicated by reference numeral M2 in FIG. 10B, the assist unit 318 according to the first modification can apply the dry air to the shaft-like solvent (solvent shaft) ejected from the nozzle 12 or the drop-like solvent ejected from the nozzle 12.

More specifically, the assist unit 318 atomizes the solvent as indicated by reference numeral M2 in FIG. 10B by applying the air (dry air) jetted from the air jetting unit 318c to the solvent supplied from the solvent supply unit 105. The atomization of the solvent is realized, for example, by increasing the pressure of the air. By atomizing the solvent, the cleaning area of the component by the solvent is enlarged as compared with the case where the solvent is not atomized.

The control unit 101 includes a cleaning control unit 101a as a functional element for controlling head cleaning by the solvent supply unit 105 and the assist unit 318. The configuration of the cleaning control unit 101a is similar to that of the above-described embodiment.

### Significance of First Modification

In the case of a general continuous inkjet recording apparatus, ink particles continue to fly in the internal space of the print head. Therefore, dirt is likely to accumulate inside the print head. The interior of the print head needs to be periodically cleaned.

Conventionally, cleaning (head cleaning) of a print head has been performed by spraying a solvent into the print head by a user himself or herself, or by automatically ejecting the solvent from a cleaning nozzle provided in the print head after the print head is placed on a cleaning placement portion as known.

However, in any of the above-described head cleaning, it is necessary to remove the print head from the production line (corresponding to the conveyance line L in the present specification). For example, in the case of manual cleaning by the user himself/herself, it is necessary to move the print head to a place where a tray for the solvent is arranged after removing the print head.

On the other hand, in the case of automatic cleaning in which a solvent is ejected into automatic droplets, it is necessary to remove the print head and then move the print head to a place where a mounting table (also referred to as a cleaning table, a cleaning placement portion, and a cleaning station) that receives the solvent is arranged.

As described above, the act of removing the print head from the production line, moving the print head to the cleaning place, and reinstalling the print head in the original position again after the cleaning takes time and effort, and there is a risk that the print head is dropped during the process. In addition, if the production line is frequently stopped, there is also a possibility that a print takt is lowered. In addition, there has been concern about securing personnel for such installation work and education to each person.

The problem to be solved by the first modification is to improve the usability of the inkjet recording apparatus by enabling the print head to be cleaned without being detached from the production line.

In view of such a problem, according to the first modification, it is possible to reduce the amount of solvent consumed in the head cleaning by the amount by which the assist unit 18 assists the head cleaning. As a result, solvent leakage from the print head 1 is suppressed. By suppressing leakage of the solvent, head cleaning with the solvent can be realized without using a tray for the solvent, a dedicated mounting table, or the like. This allows the print head 1 to be cleaned without removal from the production line.

In addition, as exemplified in FIG. 10B, the solvent supplied from the solvent supply unit 105 is atomized by air and then blown onto the components in the print head 1. The atomization of the solvent contributes to expansion of a cleaning area of the component. This makes it possible to ensure sufficient cleaning capability even with a small amount of solvent. That is, regardless of the posture of the print head 1, leakage of the solvent from the print head 1 can be suppressed while reliably cleaning a specific component (for example, the second electrode plate 152). Thus, the usability of the inkjet recording apparatus I can be improved.

In particular, it is possible to increase the degree of freedom of installation of the print head 1 by achieving the securing of cleaning capability and the suppression of solvent leakage regardless of the posture of the print head 1. Thus, the usability of the inkjet recording apparatus I can be improved.

In addition, the characteristic portion for suppressing the leakage of the solvent from the ejection port 10a and the characteristic portion for reducing the solvent use amount, such as the adjustment of the flow direction of the mist by the folding curved surface 152c and the management of the solvent use amount by the cleaning control unit 101a as the cleaning management unit, both contribute to enabling the print head 1 to be cleaned without being detached from the production line, and eventually, contribute to improvement of usability of the inkjet recording apparatus I.

Further, as exemplified in FIGS. 10A and 11, by arranging the air jetting unit 18c on the first electrode plate 151, the air jetting unit 18c and the shaft-like solvent can be brought as close as possible. This is advantageous in that blowing of the solvent is more reliably realized and a sufficient cleaning effect is exhibited while reducing the solvent consumption amount. The arrangement of the air jetting unit 18c on the first electrode plate 151 also contributes to the compactness of the print head 1.

In the first modification, the cleaning control unit 101a is configured to manage the solvent use amount by performing the processes such as steps SB3 and SB4 in FIG. 8. However, instead of such a configuration, the shutter 21 and the suction device 22 as in the above embodiment may be used. By controlling the amount of solvent used and using at least one of the shutter 21 and the suction device 22, leakage of the solvent from the ejection port 10a can be suppressed.

### Second Modification of Inkjet Recording System S

In the above embodiment and the first modification, "air assist" using air and a solvent ejected from the nozzle 12 have been used, but it is not essential to use these. Cleaning may be mechanically assisted without using air, or upon such assist, a solvent ejected from the cleaning nozzle 17 may be used instead of the solvent ejected from the nozzle 112.

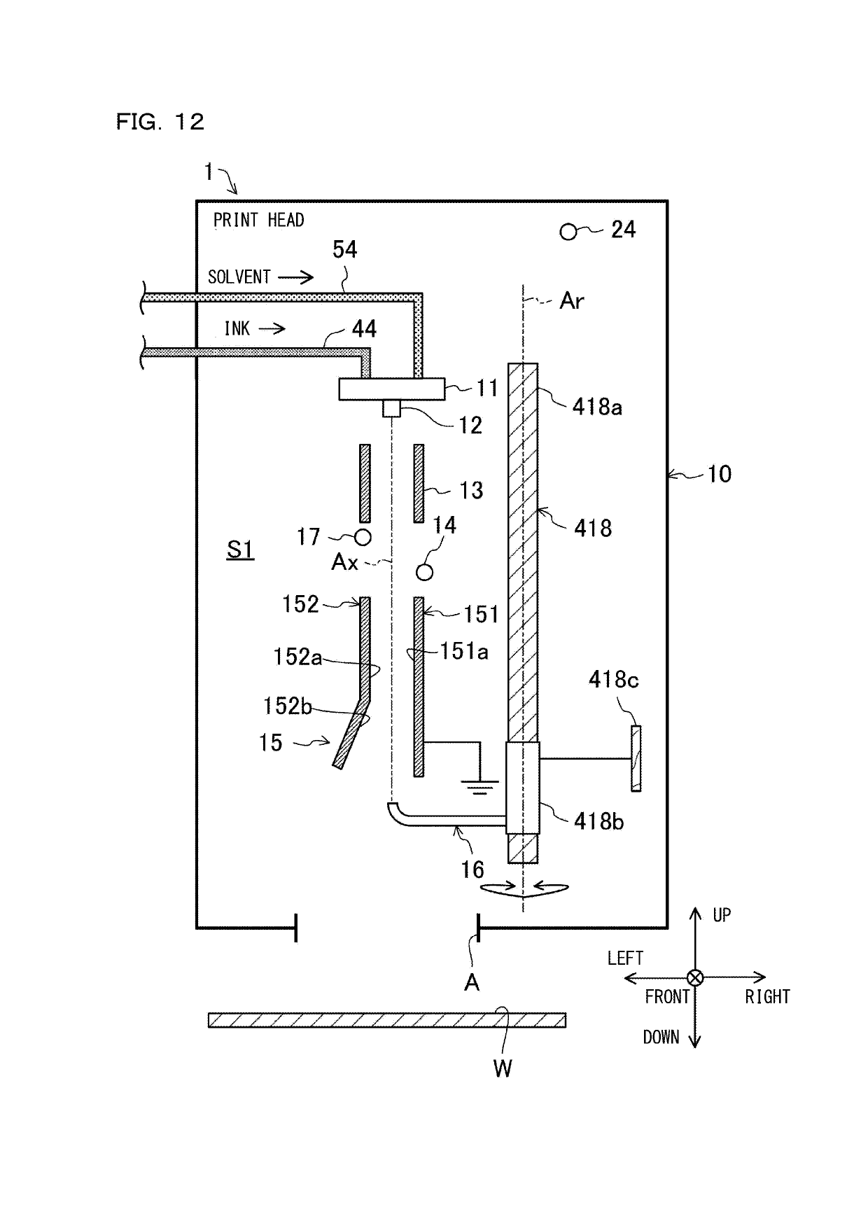

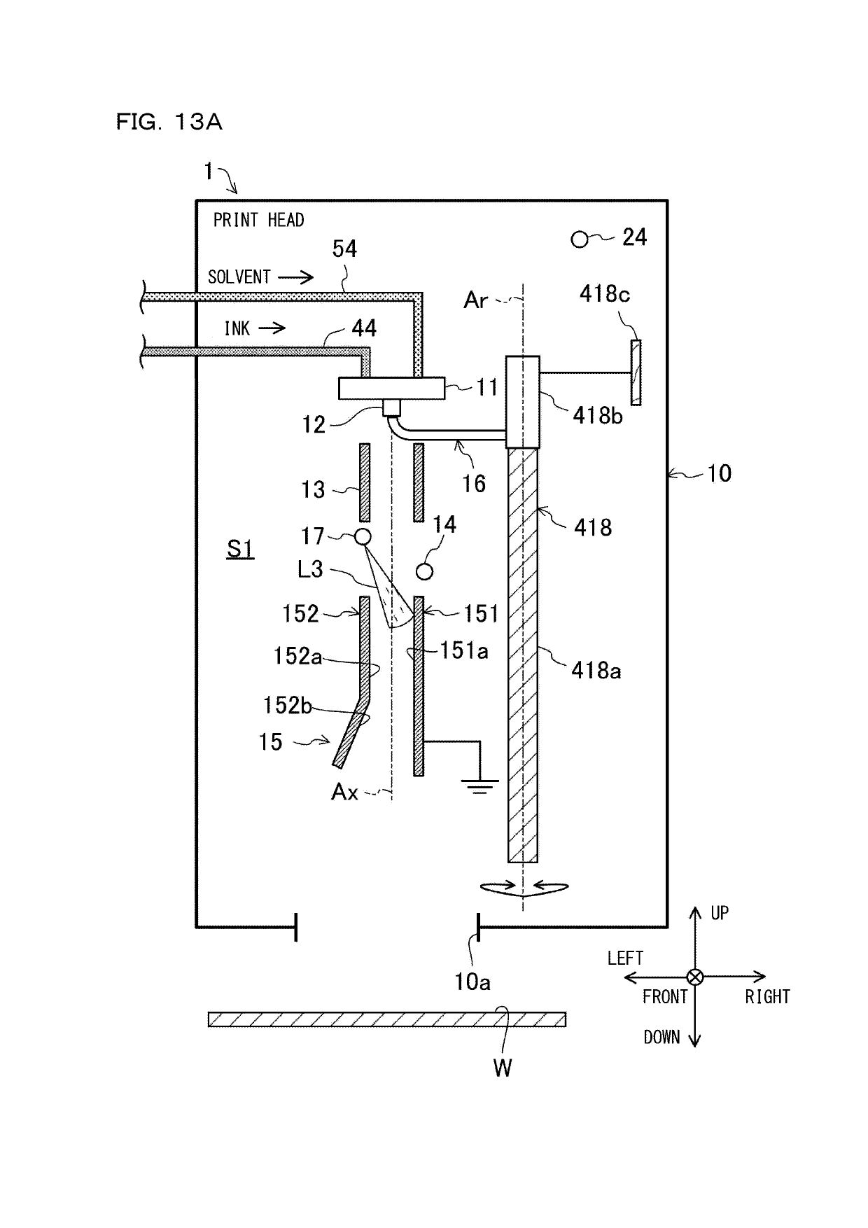

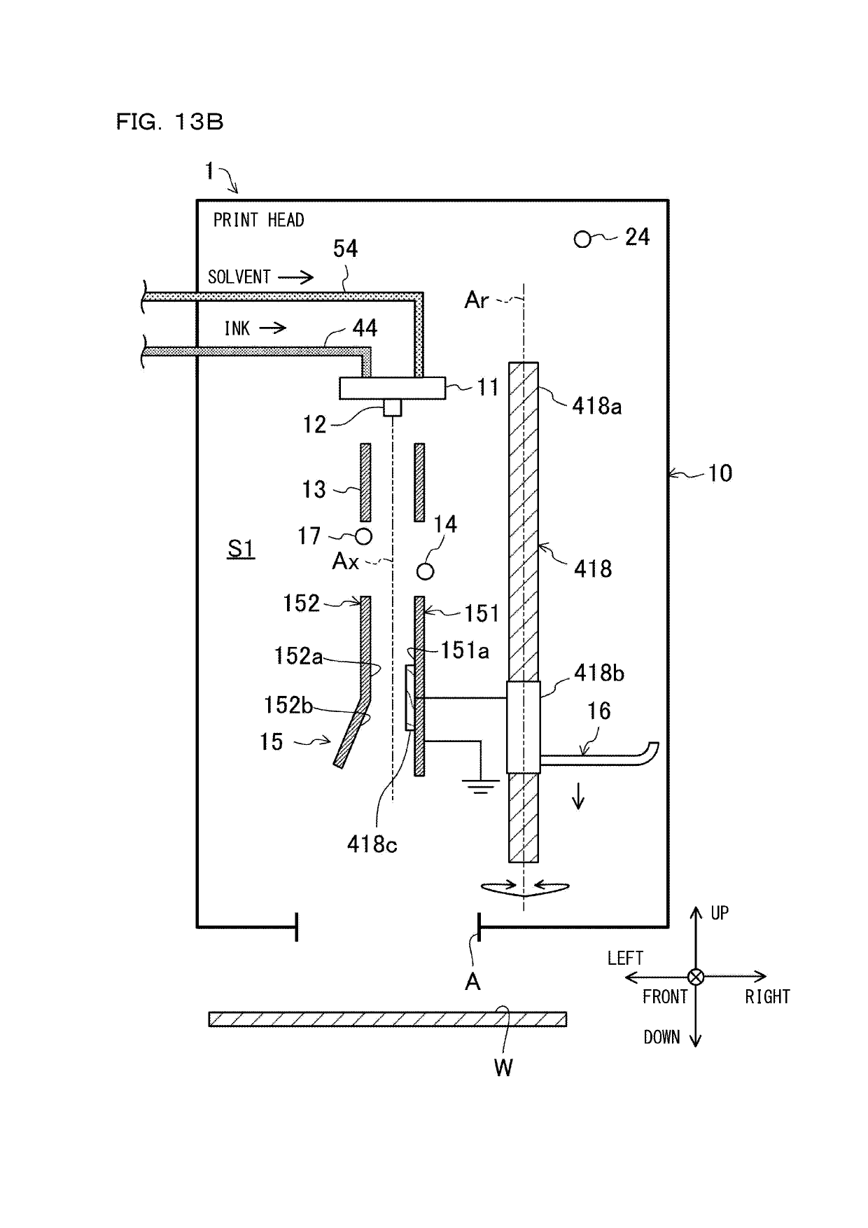

FIG. 12 is a diagram corresponding to FIG. 4A illustrating a second modification of the inkjet recording system S. FIGS. 13A and 13B are diagrams illustrating an operation of an assist unit 418 according to the second modification. In FIGS. 12, 13A, and 13B, elements having the same configurations and structures as those of the embodiment are denoted by the same reference numerals as those of the embodiment.

The print head 1 according to the second modification includes a cleaning nozzle 17 that jets a solvent similarly to the embodiment. As exemplified by reference numeral L3 in FIG. 13A, the solvent jetted from the cleaning nozzle 17 is blown to at least the deflection electrode 15. Thus, in head cleaning with assist, the deflection electrode 15 can be cleaned with the solvent supplied from the cleaning nozzle 12.

Similarly to the embodiment and the first modification, the print head 1 according to the second modification includes the assist unit 418 that assists the cleaning when cleaning the components accommodated inside the print head 1 with the solvent supplied from the solvent supply unit 105.

Unlike the embodiment and the first modification, the assist unit 418 is located inside the print head 1 and includes a contact portion 418c that mechanically contacts components accommodated inside the print head 1. That is, unlike the embodiment and the first modification, the assist unit 418 according to the second modification executes "mechanical assist".

Specifically, the assist unit 418 according to the second modification includes a rail member 418a, a moving member 418b, and a contact portion 418c.

The rail member 418a extends in the up-down direction as indicated by a chain line in FIG. 13A.

The moving member 418b moves up and down along the central axis of the rail member 418a by receiving a control signal from the controller 100 and driving. For example, a linear stepping motor may be used as a power source of the moving member 418b.

The moving member 418b rotates by 180° with respect to the rail member 418a by receiving a control signal from the controller 100. The rotation axis Ar of the moving member 418b is as indicated by a chain line in FIG. 12.

A gutter 16 and the contact portion 418c are attached to the moving member 418b so as to move integrally with the moving member 418b. The contact portion 418c is attached to the moving member 418b on the opposite side of the gutter 16 (in particular, the opposite side in the left-right direction). In the second modification, it is not essential to integrally move the moving member 418b and the gutter 16.

By rotating the moving member 418b with respect to the rail member 418a, it is possible to switch between a state in which the tip of the gutter 16 faces the nozzle 12 as illustrated in FIG. 12 and a state in which the contact portion 418c faces the nozzle 12 as illustrated in FIG. 13B. Hereinafter, the former state is referred to as a first state, and the latter state is referred to as a second state.

Here, the contact portion 418c may be made of sponge having water absorbency or cloth. In the second state described above, the contact portion 418c is in contact with at least one of the nozzle 12, the charging electrode 13, and the deflection electrode 15.

In at least the second modification and the third modification, the solvent ejected from the cleaning nozzle 17 is blown to at least one of the nozzle 12, the charging electrode 13, and the deflection electrode 15. A component to which the solvent ejected from the cleaning nozzle 17 is blown and a component with which the contact portion 418c is in contact at least partially overlap with each other. In this example, it is assumed that the solvent is blown onto the first electrode plate 151 and the contact portion 418c is in contact with the first electrode plate 151.

As illustrated in FIG. 13A, when the inkjet recording apparatus I is in the non-printable state (state in which ink is not circulated), the control unit 101 sets the moving member 418b to the first state and then moves the moving member 418b upward until the moving member 418b comes into close contact with the nozzle 12. By bringing the gutter 16 and the nozzle 12 into close contact with each other, drying of the nozzle 12 is suppressed.

Thereafter, the control unit 101 causes the cleaning nozzle 17 to eject the solvent. As a result, the solvent is blown onto at least one of the nozzle 12, the charging electrode 13, and the deflection electrode 15 (for example, the first electrode plate 151). The component blown with the solvent is wetted by the solvent.

Thereafter, the control unit 101 brings the moving member 418b into the second state and then moves the moving member 418b downward. As a result, as illustrated in FIG. 13B, at least one of the nozzle 12, the charging electrode 13, and the deflection electrode 15 (for example, the first electrode plate 151) comes into contact with the contact portion 418c.

As described above, the assist unit 518 brings the contact portion 418c into contact with the component wetted by the solvent supplied from the solvent supply unit 105, specifically, the cleaning nozzle 17. This contact assists cleaning with the solvent.

Specifically, in the example illustrated in FIGS. 13 A and 13B, the assist unit 418 moves the contact portion 418c downward while bringing the contact portion 418c into contact with the first electrode plate 151. By moving the contact portion 418c, the solvent supplied from the solvent supply unit 105 is wiped off the contact portion 418c. By wiping off the solvent, dirt adhering to the first electrode plate 151 is easily removed. In addition, by moving the contact portion 418c, the cleaning area of the component by the solvent is enlarged as compared with the case where the contact portion 418c is not moved.

As a functional element for controlling the head cleaning by the solvent supply unit 105 and the assist unit 18, the control unit 101 includes the cleaning control unit 101a described above. The function of the cleaning control unit 101a is the same as that of the above embodiment.

That is, the cleaning control unit 101a as a cleaning management unit manages the amount of solvent used at the time of cleaning so that the surface of the component is wetted by the solvent supplied from the solvent supply unit 105. Unlike the "air assist", this management is realized by controlling the opening/closing time of the 15th valve V15.

The cleaning control unit 101a can change the head cleaning sequence based on the detection signal of the posture sensor 24. The sequence to be changed includes, for example, the amount of solvent supplied from the solvent supply unit 105. This suppresses solvent leakage from the print head 1, particularly its housing 10.

### Significance of Second Modification

As described above, according to the second modification, as exemplified in FIG. 13B, the assist unit 418 assists the head cleaning. The amount of solvent consumed in the head cleaning can be reduced by the assist by the assist unit 418. Accordingly, the convenience of the inkjet recording apparatus I can be enhanced.

In addition, as exemplified in FIG. 13B, the solvent supplied from the solvent supply unit 105 can be rubbed against the components (for example, the first electrode plate 151) in the print head 1 by the contact portion 418c. By rubbing the solvent against the component, dirt adhering to the component is easily removed. This makes it possible to exhibit a sufficient cleaning effect while reducing the solvent consumption amount.

In addition, as exemplified in FIGS. 13A and 13A, the solvent supplied from the solvent supply unit 105 can be wiped off from the components in the print head 1 by the contact portion 418c. Wiping of the solvent contributes to the enlargement of the cleaning area of the component. This makes it possible to exhibit a sufficient cleaning effect while reducing the solvent consumption amount.

The cleaning control unit 101a as a cleaning management unit controls the opening/closing time of the 15th valve V15 to manage the amount of solvent used. By this, together with the assist of the cleaning by the assist unit 418, the solvent consumption amount can be further reduced.

### THIRD MODIFICATION OF INKJET RECORDING SYSTEM S

Each of the embodiment, the first modification, and the second modification has a configuration including the assist unit 18, 318, 418 as an element of the print head 1, but the present disclosure is not limited to such a configuration.

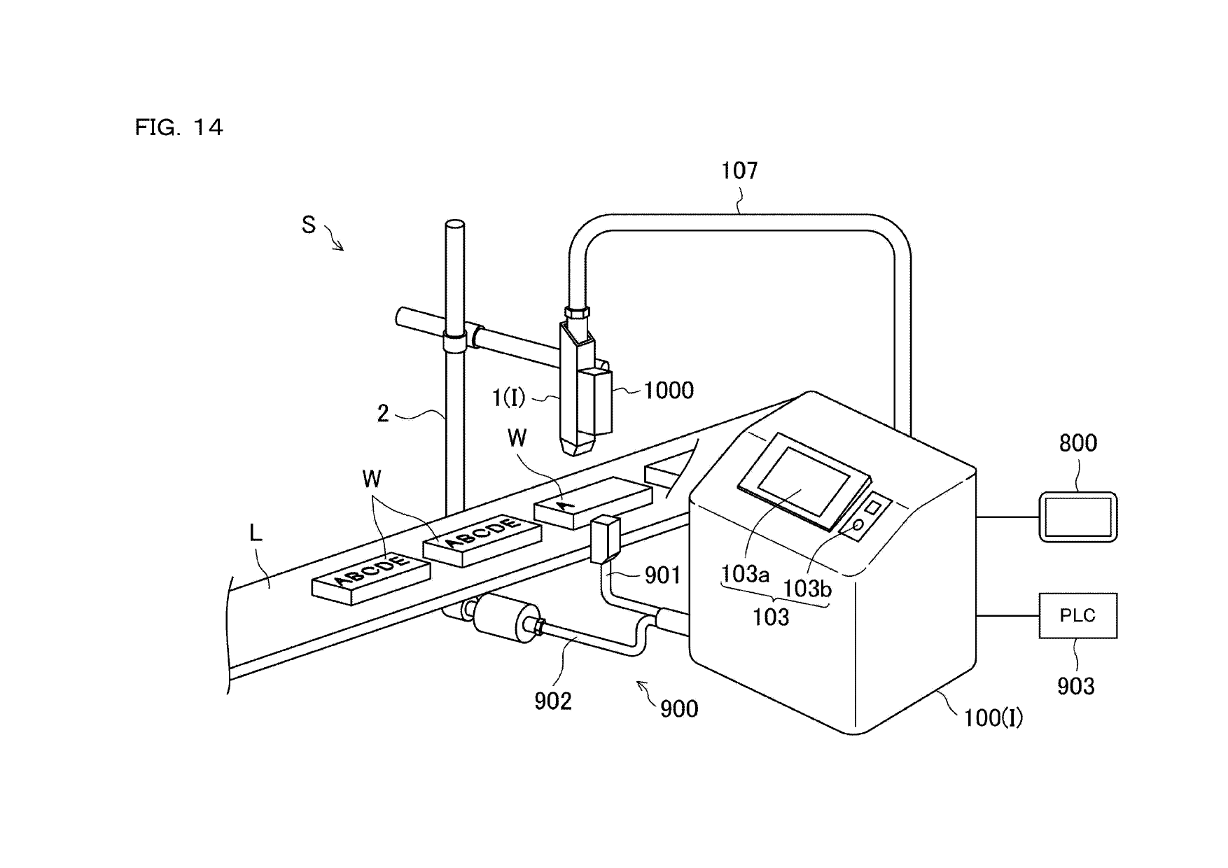

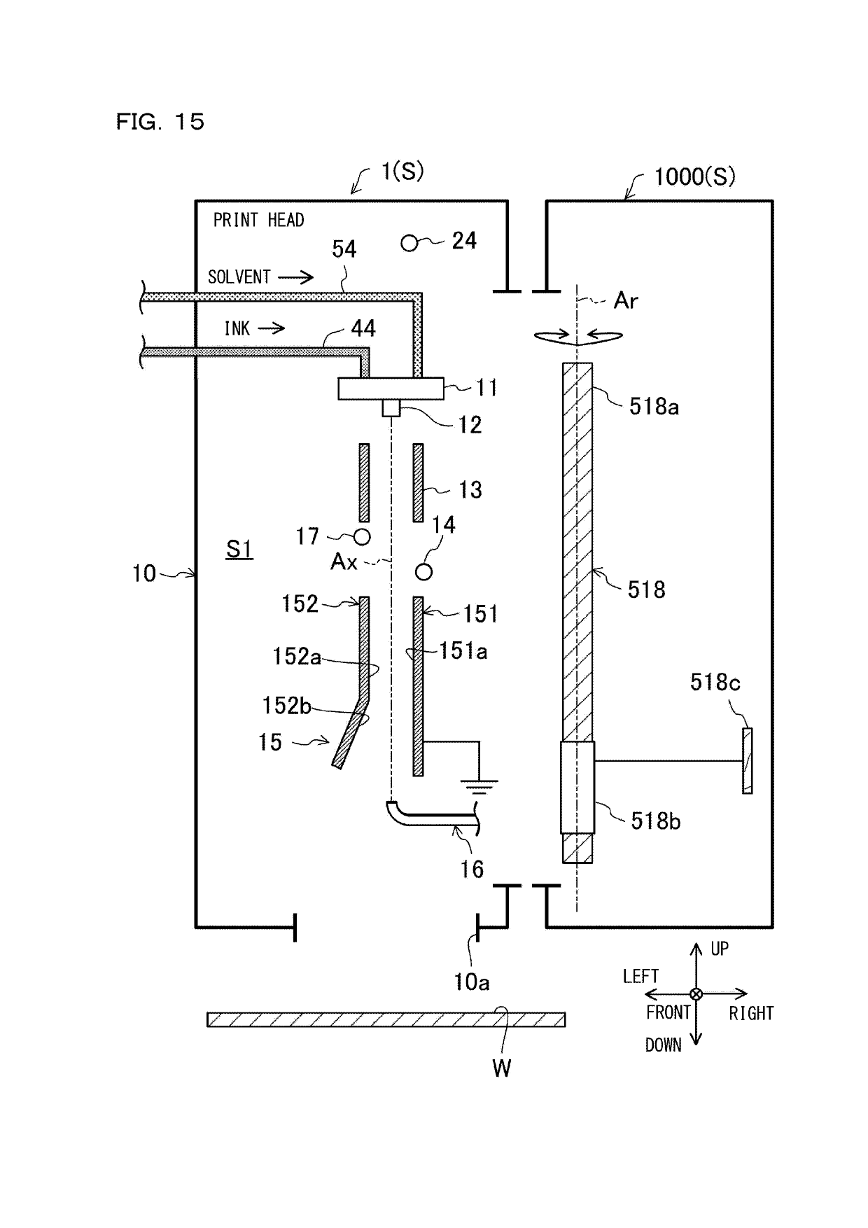

The assist unit according to the present disclosure may be configured by a member separate from the inkjet recording apparatus I, rather than the print head 1. Such a configuration will be described with reference to FIGS. 14 and 15. FIG. 14 is a diagram corresponding to FIG. 1 illustrating a third modification of the inkjet recording system S. FIG. 15 is a diagram corresponding to FIG. 4A illustrating the third modification of the inkjet recording system S. In FIGS. 14 and 15, elements having the same configurations and structures as those of the embodiment are denoted by the same reference numerals as those of the embodiment.

As illustrated in FIG. 14, the inkjet recording system S according to the third modification includes an inkjet recording apparatus I and a cleaning apparatus 1000. The inkjet recording apparatus I includes a print head 1 and a controller 100, and is a continuous inkjet recording apparatus that performs printing by causing ink ejected from the print head 1 to land on a printing target object W. Similarly to the configuration described with reference to FIG. 2, the controller 100 includes an ink supply unit 104.

On the other hand, as illustrated in FIG. 15, the cleaning apparatus 1000 is mounted to the print head 1, and includes an assist unit 518 that assists cleaning when cleaning components accommodated inside the print head 1 with a solvent supplied from a solvent supply unit 105 (not illustrated).

Similarly to the embodiment and the first modification, the print head 1 according to the third modification includes the assist unit 518 that assists the cleaning when cleaning the components accommodated inside the print head 1 with the solvent supplied from the solvent supply unit 105.

The assist unit 518 according to the third modification includes a rail member 518a, a moving member 518b, and a contact portion 518c. The assist unit 518 executes "mechanical assist" similarly to the second modification.

The assist unit 518 according to the third modification brings the contact portion 518c into contact with a component wetted with the solvent supplied from the solvent supply unit 105, specifically, the cleaning nozzle 17. The assist unit 518 assists cleaning with the solvent by bringing the contact portion 518c into contact with the wet component.

Note that the configuration of FIG. 14 is merely an example. The print head 1 may be removed from the transport line L, and the print head 1 may be transported and mounted to the cleaning apparatus 1000 arranged in a specific location.

Note that the configuration of FIG. 15 is merely an example. Similarly to the embodiment and the first modification, the cleaning apparatus 1000 may perform "air assist".

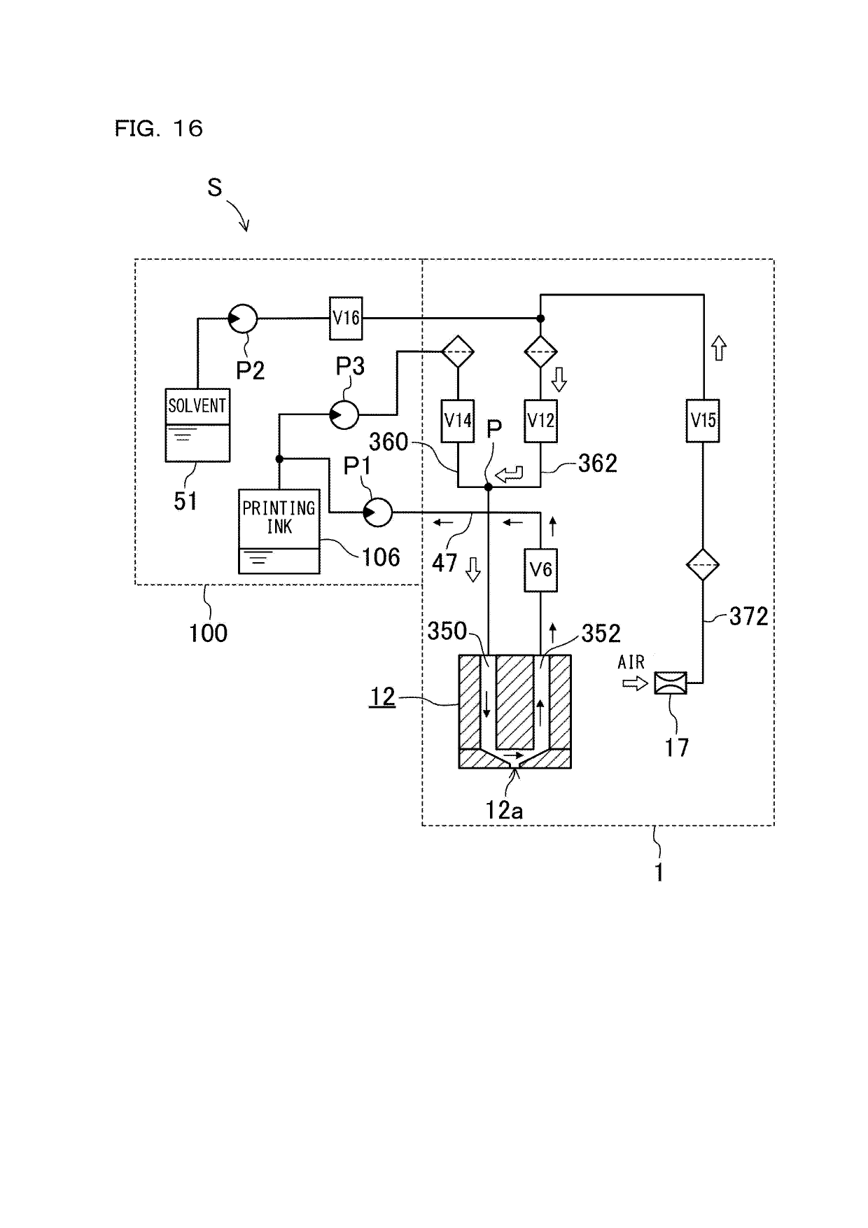

Although FIG. 5 illustrates the paths of the ink and the solvent, FIG. 16 illustrates a flow path diagram obtained by extracting elements related to cleaning of the print head 1 from FIG. 5. In the flow path diagram illustrated in FIG. 16, the controller 100 has an ink tank 106 which is a supply source of the ink liquid of which viscosity is adjusted. A quick-drying ink liquid is stored in the ink tank 106. The ink tank 106 can also be referred to as a "main tank". The ink liquid in the ink tank 106 is supplied to the print head 1 by a third pump (ink pump) P3.

The controller 100 also includes a solvent cartridge 51 as a solvent supply source. In the solvent cartridge 51, for example, methyl ethyl ketone (MEK) is accommodated. The solvent in the solvent cartridge 51 is supplied to the print head 1 by a second pump (solvent pump) P2. An openable/closable solvent electromagnetic valve V16 (not illustrated in FIG. 5) is arranged downstream of the second pump P2. When it is not necessary to supply the solvent to the print head 1, the solvent electromagnetic valve V16 is closed.

The controller 100 includes a first pump (suction pump or circulation pump) P1 that collects the ink liquid dropped on the gutter and returns the ink liquid to the ink tank 106. When the print head 1 is cleaned in a down process, the cleaning liquid (solvent) is collected from the print head 1 to the ink tank 106 by operating the first pump P1. Instead of collecting the cleaning solution in the ink tank 106, the cleaning solution may be collected in a conventionally known conditioning tank (not illustrated) installed in the controller 100 separately from the ink tank 106.

The print head 1 includes an ink line 360 that receives supply of ink from the ink tank 106 and a solvent line 362 that receives supply of a cleaning liquid (solvent) from the solvent cartridge 51. A 14th valve V14 is interposed in the ink line 360. A 12th valve V12 is interposed in the solvent line 362. The ink line 360 and the solvent line 362 are joined at the downstream end thereof to form a supply path 350. The illustrated reference sign P indicates a merging point. The supply path 350 reaches an ejection port 12a of the nozzle 12. The nozzle ejection port 12a also communicates with a suction path 352, and the suction path 352 is connected to the first pump P1 described above.

By opening the 14th valve V14, the ink liquid in the ink tank 106 is supplied to the supply path 350. On the other hand, by opening the 12th valve V12, the solvent (cleaning liquid) in the solvent cartridge 51 is supplied to the supply path 350.

The supply path 350 and the suction path 352 are formed of a tube except for the nozzle 12. The tube may be formed of a PTFE tube as in the conventional case, but may be formed of a PFA tube having the same diameter as in the conventional case. The PFA tube has a surface roughness smaller than that of the PTFE tube and is excellent in water repellency. This property makes it easier for the cleaning liquid to coat the film in the PFA tube.

A sixth valve V6 is interposed in the suction path 352 (suction path 47), and the ink liquid and the solvent in the print head 1 are collected in the ink tank 106 by the first pump P1 by opening the sixth valve V6.

The print head 1 has the cleaning nozzle 17 to clean the nozzle 12 of the print head 1. As described above, the cleaning nozzle 17 is used to eject the cleaning liquid (solvent) from the cleaning nozzle 17 to clean the nozzle ejection port 12a and the like. Specifically, the cleaning nozzle 17 may be arranged to face the nozzle ejection port 12a inside the print head 1, or may be arranged to face the charging electrode 13 or the deflection electrode 15. The cleaning nozzle 17 communicates with the solvent cartridge 51 via an openable and closable 15th valve V15. When the nozzle 12 is cleaned, the 12th valve V12 is opened and the 15th valve V15 is opened, and the solvent supplied from the solvent cartridge 51 is jetted from the cleaning nozzle 17.

Note that air may be sucked from the cleaning nozzle 17 to dry the nozzle 12. Specifically, air may be sent as indicated by an arrow in FIG. 16 by closing the solvent electromagnetic valve V16 and the 14th valve V14, opening the 12th valve V12 and the sixth valve V6, and operating the first pump P1. Accordingly, the drying of the nozzle 12 can be accelerated. As described above, the cleaning nozzle 17 may have both a function of ejecting a solvent and a function of sucking air.

What is claimed is:

1. A continuous inkjet recording apparatus comprising:
a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside;
an ink supply unit that supplies ink to the print head;
a solvent supply unit that supplies a solvent to the print head; and
a control unit that controls ink supply from the ink supply unit to the print head, and controls solvent supply from the solvent supply unit to the print head, wherein
printing is performed by causing the ink ejected from the print head to land on a printing target object, and
the print head includes an assist unit that assists cleaning of a component accommodated inside the print head when the cleaning is performed by a solvent supplied from the solvent supply unit.

2. The inkjet recording apparatus according to claim 1, wherein
the assist unit includes an air jetting unit that jets air into the print head, and
the assist unit assists the cleaning by bringing the air jetted from the air jetting unit into contact with a solvent supplied from the solvent supply unit.

3. The inkjet recording apparatus according to claim 2, wherein
the assist unit applies air jetted from the air jetting unit to a solvent supplied from the solvent supply unit to atomize the solvent, thereby expanding a cleaning area of the component by the solvent.

4. The inkjet recording apparatus according to claim 2, wherein
the print head includes an ink ejection port for ejecting ink deflected by the deflection electrode to the outside, and
the control unit includes a cleaning management unit that manages an amount of solvent used at the time of cleaning so that an amount of solvent corresponding to air jetted from the air jetting unit is supplied.

5. The inkjet recording apparatus according to claim 1, wherein
the assist unit includes a contact portion located inside the print head and in mechanical contact with the component, and
the assist unit assists the cleaning by bringing the contact portion into contact with a component wetted with a solvent supplied from the solvent supply unit.

6. The inkjet recording apparatus according to claim 5, wherein
the assist unit brings the contact portion into contact with a solvent supplied from the solvent supply unit and wipes off the solvent, thereby expanding a cleaning area of the component by the solvent.

7. The inkjet recording apparatus according to claim 5, wherein
the control unit includes a cleaning management unit that manages an amount of solvent used during the cleaning so that a surface of the component is wetted by a solvent supplied from the solvent supply unit.

8. The inkjet recording apparatus according to claim 2, wherein
the air jetting unit jets air toward the deflection electrode, and is arranged so as to interpose a shaft-like solvent ejected from the nozzle between the air jetting unit and the deflection electrode.

9. The inkjet recording apparatus according to claim 8, wherein
the deflection electrode includes first and second electrode plates facing each other, and
the air jetting unit is arranged on the first electrode plate so as to jet air toward the second electrode plate.

10. The inkjet recording apparatus according to claim 9, wherein
the first electrode plate is grounded.

11. The inkjet recording apparatus according to claim 10, wherein
the print head includes an ink ejection port for ejecting ink deflected by the deflection electrode to the outside, and
the second electrode plate includes:
an inclined surface inclined in a direction away from the shaft-like solvent; and
a folding curved surface extending from a distal end of the inclined surface on the ink ejection port side and curved more steeply than the inclined surface in a direction away from the shaft-like solvent.

12. The inkjet recording apparatus according to claim 2, further comprising a controller that accommodates the ink supply unit, the solvent supply unit, and the control unit therein, wherein
the controller further includes an air generation unit that generates air jetted from the air jetting unit, and
the assist unit includes a control valve for controlling ejection of the air generated by the air generation unit.

13. The inkjet recording apparatus according to claim 12, wherein
the air generation unit includes, in the controller, an air dryer that generates dry air by drying the air.

14. The inkjet recording apparatus according to claim 13, further comprising a pressure sensor that is arranged on a way from the air dryer to the assist unit and detects blockage of air.

15. The inkjet recording apparatus according to claim 1, wherein
the print head includes an ink ejection port for ejecting ink deflected by the deflection electrode to the outside, and a shutter for opening and closing the ink ejection port.

16. The inkjet recording apparatus according to claim 15, wherein
before the assist by the assist unit is performed, the control unit operates the shutter to close the ink ejection port.

17. The inkjet recording apparatus according to claim 15, further comprising a drying unit that dries an inside of the print head when the shutter closes the ink ejection port.

18. The inkjet recording apparatus according to claim 2, wherein
the control unit executes a drying treatment for drying the inside of the print head by causing the assist unit to execute assist when a solvent is not supplied from the solvent supply unit.

19. The inkjet recording apparatus according to claim 18, wherein
the control unit repeatedly and alternately performs a cleaning treatment of cleaning the component with a solvent supplied from the solvent supply unit and the drying treatment by causing the assist unit to perform assist while turning on and off solvent supply from the solvent supply unit.

20. An inkjet recording system comprising:
a continuous inkjet recording apparatus including: a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside; an ink supply unit that supplies ink to the print head; a solvent supply unit that supplies a solvent to the print head; and a control unit that controls ink supply from the ink supply unit to the print head, and controls solvent supply from the solvent supply unit to the print head, printing being performed by causing the ink ejected from the print head to land on a printing target object; and
a cleaning apparatus mounted to the print head and including an assist unit that assists cleaning when cleaning a component accommodated inside the print head with a solvent supplied from the solvent supply unit.
